(19) United States
(12) Patent Application Publication
(10) Pub. No.: US 2016/0065658 A1
(43) Pub. Date: Mar. 3, 2016

(54) EVENT AND STAFF MANAGEMENT SYSTEMS AND METHODS

(71) Applicant: CASE GLOBAL, INC., Los Angeles, CA (US)

(72) Inventors: Moshe Alon, Encino, CA (US); Uri Gal, Winnetka, CA (US)

(73) Assignee: CASE GLOBAL, INC., Los Angeles, CA (US)

(21) Appl. No.: 14/839,118

(22) Filed: Aug. 28, 2015

Related U.S. Application Data
(60) Provisional application No. 62/044,024, filed on Aug. 29, 2014.

(51) Int. Cl. H04L 29/08

(52) U.S. Cl. CPC H04L 67/10

(57) ABSTRACT

Systems and methods are described for responding to an event, the method comprising receiving, by a server over a network, a notice indicating the occurrence of the event at a facility, classifying, by the server, the event based at least in part on the notice, generating, by the server, at least one message corresponding to each of at least one device, wherein each of the at least one message is generated based, at least in part, on at least one role associated with the each of the at least one device, and transmitting, by the server over the network, the at least one message to the each of the at least one device.

### CROSS-REFERENCE TO RELATED PATENT APPLICATIONS

This application claims priority from Provisional U.S. Application 62/044,024, filed Aug. 29, 2014, which is incorporated herein by reference in its entirety.

### BACKGROUND OF THE INVENTION

Embodiments of the present invention generally relate to systems, methods, and computer-readable medium for staff management, tour management, and incident reporting/responding in a facility of various types.

Everyday, facilities such as shopping centers, office buildings, apartment buildings, assembly plants, schools, hospitals, airports, and casinos employ millions of staff members for operation, upkeep, and security of these facilities. Staff members are often charged with patrolling the premise, performing tasks at different locations within the facilities, and respond to incidents, such as emergencies. Given the number of staff members that may work in a facility and the variety of roles that each staff member may play, it may be difficult to manage time keeping, tour routes, and incident reporting/responding.

In one example, it may be difficult for employers and managers to monitor and ensure that the staff members are starting work/breaks or ending work/breaks at appropriate times, for both payroll purposes and for labor law compliance purposes. Such difficulty is due to that the staff members, such as maintenance personnel and security officers, are highly mobile and are dispersed across a facility, which may have encompass large area.

In another example, given the number of different types of staff members (e.g., security staff, cleaning crew, engineering crew, maintenance crew, and the like) as well as different roles within each type of staff members (e.g., regular security staff, guard captains, weapon-carrying security specialist, and the like), assigning tasks and designing tours based on the specific role of each staff member may be difficult to implement.

In yet another example, to espouse prompt and effective response of an incident (such as an emergency) in a facility, a mechanism to promptly notify and instruct all relevant staff members is essential. Traditional methods and systems, such as a public address system broadcasting instructions following an emergency, do not communicate to each staff member the specific tasks that the particular staff member are to perform. Rather, the staff member may have to sort through voluminous irrelevant information to retrieve his own instructions.

In addressing these deficiencies, embodiments of the present invention allow, among others, effective and efficient time keeping, tour route selection/execution, and incident report/response, as described herein.

### SUMMARY OF THE INVENTION

A method for responding to or planning for an event, the method includes, but is not limited to any one or combination of receiving, by a server over a network, a notice indicating the occurrence of the event at a facility; classifying, by the server, the event based at least in part on the notice; generating, by the server, at least one message corresponding to each of at least one device, wherein each of the at least one message is generated based, at least in part, on at least one role associated with the each of the at least one device; and transmitting, by the server over the network, the at least one message to the each of the at least one device.

In various embodiments, the method further includes requesting, by the server, additional data from a mobile device. The requesting includes, but is not limited to, activating, by the server, a communication device of the mobile device; and receiving, by the server, the additional data obtained from the communication device. In some embodiments, the notice is sent by the mobile device.

In some embodiments, the communication device is at least one of: a photographic camera of the mobile device, a video camera of the mobile device, and a microphone of the mobile device.

In various embodiments, the generating includes, but is not limited to retrieving rules based, at least in part, on the at least one role associated with the each of the at least one device; and selectively generating the at least one message based, at least in part, on the rules and the notice.

In some embodiments, the notice includes, but is not limited to at least one of: a geo-location data representing a geological location in which the event occurs, a time stamp representing the time at which the event occurred, and a user comment. In particular embodiments, the user comment is, in some embodiments, at least one of the following: a text input, a voice input, a photographic input, and a video input.

In some embodiments, the geo-location data further includes, but is not limited to, at least one of: a section of the facility associated with the geological location, an identification of the section, an address associated with the section, contact information associate with the section, and a map representing the section.

In some embodiments, the method further comprises displaying, with the server to a personnel associated with the server, a presentation of the event, the presentation comprising at least one of: a map showing a location of the event, a classification of the event, a time stamp of the event, contact information, and information of the identity of a user associated with a mobile device.

In various embodiments, the transmitting comprises forcing, by the server, the at least one device to display the corresponding at least one message. In addition, the at least one message includes, but is not limited to, a set of at least one instruction for responding to the event.

A method for responding to or planning for an event, comprising a mobile device, a plurality of devices, and a server configured to receive a notice indicating the occurrence of the event at a facility; classify the event based at least in part on the notice; generate at least one message corresponding to each of at least one device, wherein each of the at least one message is generated based, at least in part, on at least one role associated with the each of the at least one device; and transmit the at least one message to the each of the at least one device.

In various embodiments, the server is further configured to request additional data from a mobile device. In particular embodiments, the server is further configured to activate a communication device of the mobile device; and receive the additional data obtained from the communication device. In some embodiments, the mobile device is configured to send the notice.

In some embodiments, the communication device is at least one of: a photographic camera of the mobile device, a video camera of the mobile device, and a microphone of the mobile device.

In various embodiments, the generating includes, but is not limited to retrieving rules based, at least in part, on the at least one role associated with the each of the at least one device; and selectively generating the at least one message based, at least in part, on the rules and the notice.

In some embodiments, the notice includes, but is not limited to, at least one of: a geo-location data representing a geological location in which the event occurs, a time stamp representing the time at which the event occurred, and a user comment.

In some embodiments, the geo-location data further includes, but is not limited to, at least one of: a section of the facility associated with the geological location, an identification of the section, an address associated with the section, contact information associate with the section, and a map representing the section. In particular embodiments, the user comment is at least one of the following: a text input, a voice input, a photographic input, and a video input.

In various embodiments, the server is further configured to display to a personnel associated with the server, a presentation of the event, the presentation comprising at least one of: a map showing a location of the event, a classification of the event, a time stamp of the event, contact information, and information of the identity of a user associated with a mobile device.

In particular embodiment, the server is further configured to force the devices to display the message. In some embodiments, the at least one message comprises a set of at least one instruction for responding to the event.

A method for responding to or planning for an event, the method includes, but is not limited to any one or combination of receiving user input indicating the occurrence of the event at a facility; determining whether a user had cancelled sending a notice with a predetermined period of time; and sending the notice automatically when the user has not cancelled the sending of the notice.

### BRIEF DESCRIPTION OF THE DRAWINGS

FIG. 1 is a diagram illustrating a staff management system according to various embodiments.

FIG. 2 is a block diagram illustrating an example of a backend device for implementation within the staff management system according to various embodiments.

FIG. 3 is a block diagram illustrating an example of a mobile device for implementation within the staff management system according to various embodiments.

FIG. 4 is a block diagram illustrating an example of a client device for implementation within the staff management system according to various embodiments.

FIG. 5 is a diagram representing a login menu according to various embodiments.

FIG. 6 is a diagram representing a window interface according to various embodiments.

FIG. 7 is a diagram representing a selection interface according to various embodiments.

FIG. 8 is a diagram representing a time clock management interface according to various embodiments.

FIG. 9 is a process flowchart illustrating a method for time clock management of starting a break according to various embodiments.

FIG. 10 is a process flower chart illustrating a method for a time clock management of ending a break according to various embodiments.

FIG. 11 is a diagram representing a tour selection interface according to various embodiments.

FIG. 12 is a diagram representing a tour information overview interface according to various embodiments.

FIG. 13 is a diagram representing one example of a tour interface according to various embodiments.

FIG. 14 is a diagram representing another example of a tour interface according to various embodiments.

FIG. 15 is a diagram representing a checklist interface according to various embodiments.

FIG. 16 is a diagram illustrating an example of an assist system according to various embodiments.

FIG. 17 is a diagram representing a priority level selection interface according to various embodiments.

FIG. 18 is a diagram representing an incident report interface according to various embodiments.

FIG. 19 is a diagram representing a reporting timer interface according to various embodiments.

FIG. 20 is a process flowchart illustrating a method for an incident report timer process according to various embodiments.

FIG. 21 is a block diagram illustrating an incident notice according to various embodiments.

FIG. 22 is a diagram representing an incident display interface according to various embodiments.

FIG. 23 is a process flowchart illustrating a method for responding to an incident according to various embodiments.

FIG. 24 is a block diagram representing an example of separate customized instructions based on roles according to various embodiments.

FIG. 25 is a diagram representing a client device interface according to various embodiments.

FIG. 26 is a diagram representing an incidence report interface according to various embodiments.

FIG. 27 is a diagram representing a message interface according to various embodiments.

FIG. 28 is a diagram representing a message priority interface according to various embodiments.

FIG. 29 is a diagram representing a messaging interface according to various embodiments.

FIG. 30 is a diagram representing a login menu according to various embodiments.

FIG. 31 is a diagram representing a selection interface according to various embodiments.

FIG. 32 is a diagram representing a tour information overview interface according to various embodiments.

FIG. 33 is a diagram representing an attachment interface according to various embodiments.

### DETAILED DESCRIPTION OF THE PREFERRED EMBODIMENTS

In the following description of preferred embodiments, reference is made to the accompanying drawings which form a part hereof and in which are shown by way of illustration specific embodiments in which the invention may be practiced. It is to be understood that other embodiments may be utilized and structural changes may be made without departing from the scope of the preferred embodiments of the present disclosure.

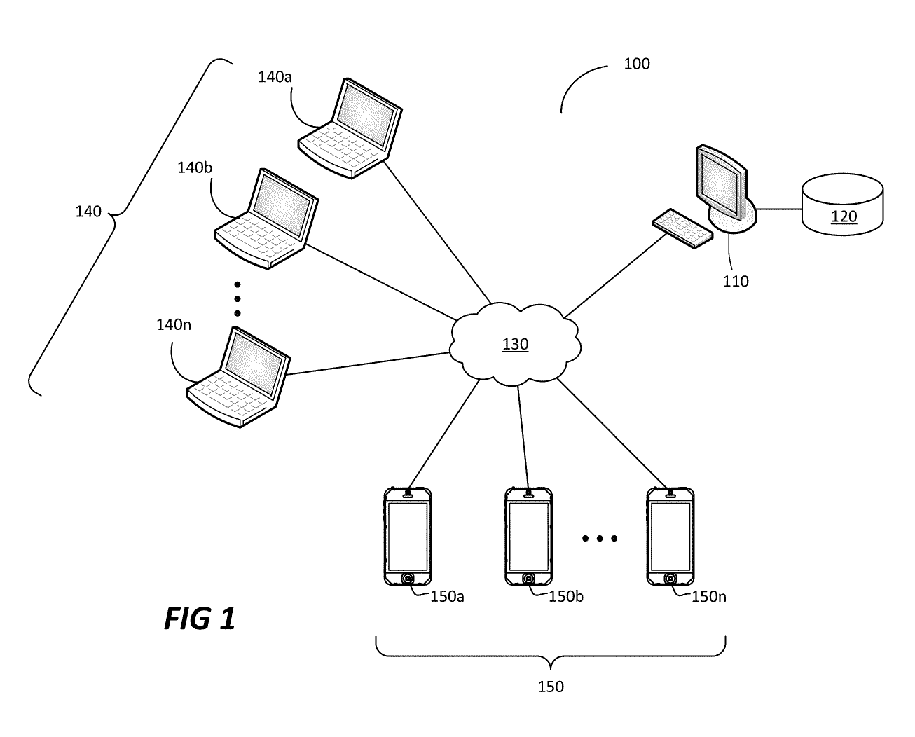

With reference to FIG. 1, a block diagram of a staff management system 100 is shown in accordance with various embodiments of the present invention. The staff management system 100 may include at least one backend device 110, at least one database 120, at least one client device 140 (represented by reference numerals 140a, 140b, . . . , 140n), and at least one mobile device 150 (represented by reference numerals 150a, 150b, . . . , 150n). Each of the at least one backend device 110, the at least one database 120, the at least one client devices 140, and the at least one mobile device 150 may be connected to one another through a network 130. The backend device 110, mobile device 150, and client device 140 may be programmed or otherwise configured to operate and provide functions described herein.

In some embodiments, the mobile device 150 may be associated with at least one user such as, but not limited to, a security staff, a cleaning crew member, an engineering crew member, a maintenance crew member, a medical professional, a member of the military, an emergency responder, and/or the like. For example, the users may be employees or independent contractors (performing service for or otherwise working in the facility) to be managed or instructed by a manger, a captain, an employer, and/or the like, who may be associated with the backend device 110. In particular embodiments, the user may use the mobile device 150 for reporting and transmitting information of incidents (or events) perceived by the user, performing time keeping tasks, receiving instructions, accessing current information related to the facility or a live event, and/or the like. As used herein, “incident” or “events” may include occurrences that had already occurred (e.g., an emergency) or planned events that has not yet occurred.

In various embodiments, the backend device 110 may represent a “command center” in which control, management, and/or distribution of information to the users associated with the mobile device 150 may occur. In particular embodiments, the backend device 110 of the staff management system 100 may be located in a security office of a shopping mall facility. In other embodiments, the backend device 110 may be located at a different location in or remote from the shopping mall facility.

In some embodiments, the client device 140 may be associated with entities and/or persons for whom the staff members perform services for. Examples of entities and persons associated with the client device 140 may include, but not limited to, stores in a shopping mall, classrooms in a school or university, hospital wards and rooms, and/or the like. For example, the client device 140 may include one or more customer devices located at one or more of the stores within the shopping mall facility. In further embodiments, the client device 140 or the mobile device 150 may include one or more devices located in or remote from the shopping mall facility and associated with a police agency, a fire agency, ambulance or other emergency agency, a hospital or other medical facility, a designated expert or consultant, or the like.

In some embodiments, the network 130 may allow data transfer between the backend device 110, the client device 140, and/or the mobile device 150. The network 130 may be a wide area communication network, such as, but not limited to, the Internet, or one or more Intranets, local area networks (LANs), ethernet networks, metropolitan area networks (MANs), a wide area network (WAN), combinations thereof, or the like. In particular embodiments, the network 130 may represent one or more secure networks configured with suitable security features, such as, but not limited to firewalls, encryption, or other software or hardware configurations that inhibits access to network communications by unauthorized personnel or entities.

Raw and unprocessed data received by the mobile device 150 (e.g., through user input or other hardware of the mobile device 150 in the manner described by this application) may be processed or stored by the mobile device 150, or, alternatively or in addition, may be stored and/or transmitted to the backend device 110, the client device 140, and/or at least one other mobile device 150 for processing. In particular embodiments, such raw and unprocessed data may include, but not limited to, sensor data (from sensors onboard or otherwise associated with the mobile device 150), location information (from location detection electronics onboard or associated with the mobile device 150), user-input data received from the user associated with the mobile device, or the like.

In embodiments in which the mobile device 150 transmits such data to the backend device 110, the client device 140, and/or at least another one of the mobile device 150, personnel (such as, but not limited to supervisors, managers, storeowners, store clerks, and/or other designated personnel) associated with the receiving device may perform various tasks based on the received data, such as, but not limited to, generating or updating schedule or tour information, providing warning or other messages to the user associated with the mobile device 150, transmitting specified pre-stored information to the mobile device 150 or the client device 140, obtaining and transmitting instantaneous sensor or detector information to the mobile device 150 or the client device 140, contacting emergency or other designated personnel, and/or the like. In further embodiments, the mobile device 150, the backend device 110, and/or the client device 140 are programmed or otherwise configured to perform one or more of the above-mentioned tasks.

Alternatively or in addition, one or more rule-based processes (e.g., software programs) employ that data to perform tasks, such as, but not limited to, generating or updating schedule or tour information, providing warning or other messages to the user associated with the mobile device 150, transmitting specified pre-stored information to the mobile device 150 or the client device 140, obtaining and transmitting instantaneous sensor or detector information to the mobile device 150 or the client device 140, contacting emergency or other designated personnel, and/or the like. In particular embodiments, the rule-based processes may be configured and/or customized for a particular service and/or a customer for whom the service may be provided. In further embodiments, the rule-based processes may be updated, adjusted, and assigned to user (and the mobile device 150 associated with the user), individually in groups. In yet further embodiments, the backend device 110 or client device 140 that receives data from the mobile device 150 may be configured to carry out some or all of the rule-based processes. Accordingly, systems and processes of embodiments of the present invention can be generally or specifically configured for particular services, customers or the like, and can be flexible and adjustable before and during operation.

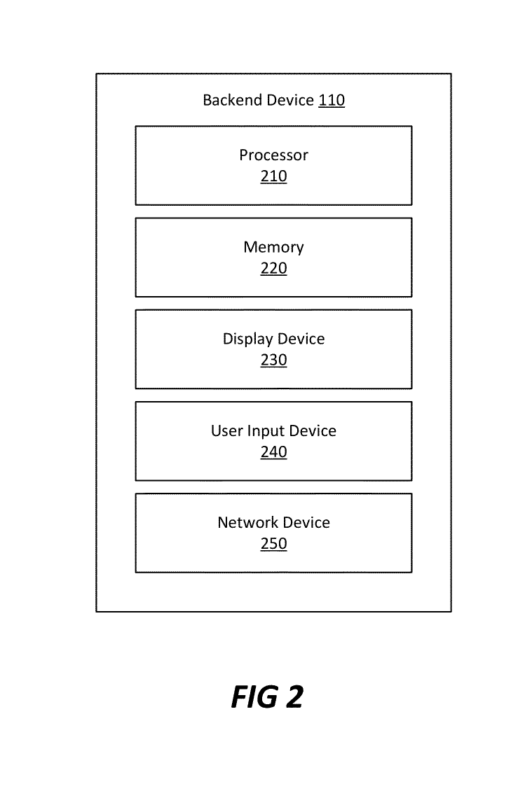

Referring to FIGS. 1-2, FIG. 2 is a block diagram illustrates an example of a backend device 110 (as represented in FIG. 1). The backend device 110 may include at least one processor 210, memory 220 operatively coupled to the processor 210, at least one display device 230, at least one user input device 240, and at least one network device 250. In some embodiments, the backend device 110 may comprise a desktop computer, mainframe computer, laptop computer, pad device, smart phone device or the like, configured with hardware and software to perform operations described herein. For example, the backend device 110 may comprise typical desktop PC or Apple™ computer devices, having suitable processing capabilities, memory, user interface (e.g., display and input) capabilities, and communication capabilities, when configured with suitable application software (or other software) to perform operations described herein. Thus, particular embodiments may be implemented, using processor devices that are often already present in many business and organization environments, by configuring such devices with suitable software processes described herein. Accordingly, such embodiments may be implemented with minimal additional hardware costs. However, other embodiments of the backend device 110 may relate to systems and process that are implemented with dedicated device hardware specifically configured for performing operations described herein.

The processor 210 may include any suitable data processing device, such as a general-purpose processor (e.g., a microprocessor), but in the alternative, the processor 210 may be any conventional processor, controller, microcontroller, or state machine. The processor 210 may also be implemented as a combination of computing devices, e.g., a combination of a DSP and a microprocessor, a plurality of microprocessors, at least one microprocessors in conjunction with a DSP core, or any other such configuration. The memory 220 may be operatively coupled to the processor 210 and may include any suitable device for storing software and data for controlling and use by the processor 210 to perform operations and functions described herein, including, but not limited to, random access memory RAM, read only memory ROM, floppy disks, hard disks, dongles or other RSB connected memory devices, or the like.

In particular embodiments, the backend device 110 may include at least one display device 230. The display device 230 may include any suitable device that provides a human-perceptible visible signal, audible signal, tactile signal, or any combination thereof, including, but not limited to a touchscreen, LCD, LED, CRT, plasma, or other suitable display screen, audio speaker or other audio generating device, combinations thereof, or the like.

In some embodiments, the backend device 110 may include at least one user input device 240 that provides an interface for personnel (such as service entity employees, technicians, or other authorized users) to access the staff management system 100 (e.g., the backend device 110 and the further data storage devices, if any) for service, monitoring, generating reports, communicating with the mobile devices 150 or the client devices 140, and/or the like. The user input device 240 may include any suitable device that receives input from a user including, but not limited to one or more manual operator (such as, but not limited to a switch, button, touchscreen, knob, slider or the like), microphone, camera, image sensor, or the like.

The network device 250 may be configured for connection with and communication over the network 130. The network device 250 may include interface software, hardware, or combinations thereof, for connection with and communication over the network 130. The network device 250 may include wireless receiver or transceiver electronics and/or software that provides a wireless communication link with the network 130 (or with a network-connected device). In particular embodiments, the network device 250 may operate with the processor 210 for providing wireless telephone communication functions. In particular embodiments, the wireless device 250 may also operate with the processor 210 for receiving locally-generated wireless communication signals from signaling devices located within a specified proximity of the backend device 110. The wireless device 250 may provide telephone and other communications in accordance with typical industry standards, such as, but not limited to code division multiple access (CDMA), time division multiple access (TDMA), frequency division multiple access (FDMA), long term evolution (LTE), wireless fidelity (WiFi), frequency modulation (FM), Bluetooth (BT), near field communication (NFC), and the like.

Still referring to FIGS. 1 and 2, in addition to (or as an alternative to) the memory 220, the backend device 110 may be operatively coupled to the at least one database 120. In some embodiments, the database 120 may be connected to the backend device 110 through the network 130. In other embodiments, the database 120 may be connected to the backend device 110 in other suitable manners not through the network 130. In particular embodiments, the database 120 may be capable of storing a greater amount of information and provide a greater level of security against unauthorized access to stored information, than the memory 220 in the backend device 110 (or similar electronic storage devices in the client device 140 and mobile devices 150). The database 120 may comprise any suitable electronic storage device or system, including, but not limited to random access memory RAM, read only memory ROM, floppy disks, hard disks, dongles or other RSB connected memory devices, or the like. In further embodiments, the database 120 may be connected to the mobile device 150 or the client device 140 for storing information transmitted by the mobile device 150 or the client device 140, in a manner described with respect to the backend device 110.

Now referring to FIGS. 1-3, FIG. 3 illustrates an example of a mobile device 150 (as represented in FIG. 1, and also represented by reference characters 150a, 150b, . . . , 150n). Each mobile device 150 may include at least one processor 310, memory 320 operatively coupled to the processor 310, at least one display device 330, at least one user input device 340, and at least one network device 350, such as, but not limited to those described above with respect to the processor 210, the memory 220, the display device 230, the user input device 240, and the network device 250 of the backend device 110. In some embodiments, each mobile device 150 may also include at least one geo-location device 360, at least one user notification device 370, at least one timer device 380, and at least one near field communication (NFC) or quick response (QC) code scanner 390.

The hardware and the software of the mobile device 150 may support the execution of the staff management system 110 as described, where staff management system 110 may employ an application (such as a smartphone app) or a web-based browser logic to realize function described. In particular embodiments, the backend device 110 may be configured to provide one or more network sites (such as, but not limited to secure websites or web pages) that can be accessed over the network 130 by the user associated with the mobile device 150.

The geo-location device 360 may include hardware and software for determining geographic location of the mobile device 150, such as, but not limited to a global positioning system (GPS) or other satellite positioning system, terrestrial positioning system, Wi-Fi location system, combinations thereof, or the like. In various embodiments, each mobile device 150 may include at least one user notification device 370, having hardware and software to notify the user by any suitable means to attract the user's attention, including, but not limited to, a light flashing feature, a vibration feature, an audio notification, and/or the like. In some embodiments, each mobile device 150 may include at least one timer device 380 that provides time information for determining a time of day and/or for timing a time period. Alternatively or in addition, each mobile device 150 may be configured to obtain such time information from the backend device 110, the client device 140, and/or other suitable sources over the network 130.

The NFC/QR scanner 390 may include hardware and software for reading and receiving information contained in a NFC code or a QR code. For example, the NFC/QR scanner 390 may be devices internal to the mobile device 150 or operatively connected to the mobile device 150, and may include, but not limited to, a NFC card reader, a NFC tag reader, a QR code scanner, the appropriated applications, and/or the like. Furthermore, the mobile device 150 may be configured to take a photograph of the QR codes such that applications residing on the mobile device 150 may be configured to read the information contained within the QR codes.

In particular embodiments, each mobile device 150 may comprise a mobile smart phone (such as, but not limited to an iPhone™, an Android™ phone, or the like) or other mobile phone with suitable processing capabilities. Typical modern mobile phone devices include telephone communication electronics as well as some processor electronics, one or more display devices and a keypad and/or other user input device, such as, but not limited to described above. Particular embodiments employ mobile phones, commonly referred to as smart phones, that have relatively advanced processing, input and display capabilities in addition to telephone communication capabilities. However, the mobile device 150, in further embodiments of the present invention, may comprise any suitable type of mobile phone and/or other type of portable electronic communication device, such as, but not limited to, an electronic smart pad device (such as, but not limited to an iPad™), a portable laptop computer, or the like.

In embodiments in which the mobile device 150 comprises a smart phone or other mobile phone device, the mobile device 150 may have existing hardware and software for telephone and other typical wireless telephone operations, as well as additional hardware and software for providing functions as described herein. Such existing hardware and software includes, for example, one or more input devices (such as, but not limited to keyboards, buttons, touchscreens, cameras, microphones, environmental parameter or condition sensors), display devices (such as, but not limited to electronic display screens, lamps or other light emitting devices, speakers or other audio output devices), telephone and other network communication electronics and software, processing electronics, electronic storage devices and one or more antennae and receiving electronics for receiving various signals, e.g., for global positioning system (GPS) communication, wireless fidelity (WiFi) communication, code division multiple access (CDMA) communication, time division multiple access (TDMA), frequency division multiple access (FDMA), long term evolution (LTE) communication, frequency modulation (FM) communication, Bluetooth (BT) communication, near field communication (NFC), and the like. In such embodiments, some of that existing electronics hardware and software may also be used in the systems and processes for functions as described herein.

Accordingly, such embodiments can be implemented with minimal additional hardware costs. However, other embodiments relate to systems and process that are implemented with dedicated device hardware (mobile device 150) specifically configured for performing operations described herein. Hardware and/or software for the functions may be incorporated in the mobile device 150 during manufacture of the mobile device 150, for example, as part of the original manufacturer's configuration of the mobile device 150. In further embodiments, such hardware and/or software may be added to a mobile device 150, after original manufacture of the mobile device 150, such as by, but not limited to, installing one or more software applications onto the mobile device 150.

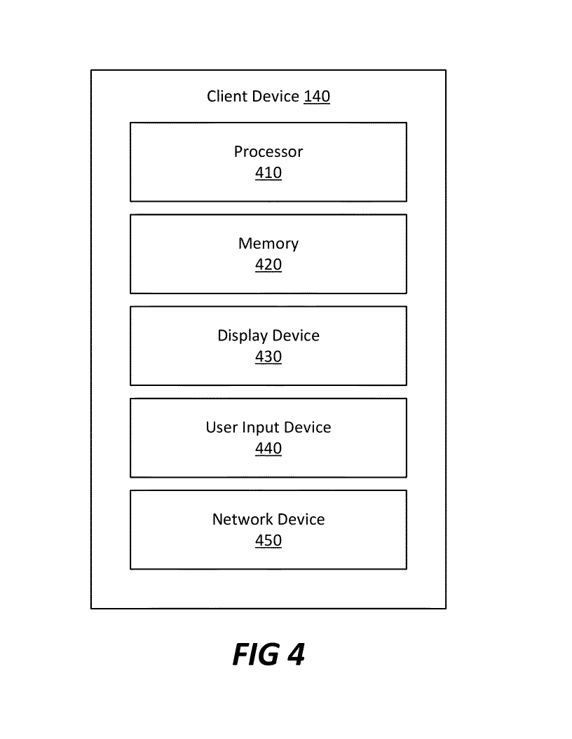

FIG. 4 illustrates an example of a client device 140 (as represented in FIG. 1, and also represented by reference characters 140a, 140b, . . . , 140n). Each client device 140 may include at least one processor 410, memory 420 operatively coupled to the processor, at least one display device 430, at least one user input devices 440, and at least one network device 450, such as, but not limited to those described above with respect to the processor 210, the memory 220, the display device 230, the user input device 240, and the network device 250 of the backend device 110. In addition, the processor 410 may include, but not limited to, one or more service processors (processors associated with running a service with the system 100), customer processors (processors associated with customers using the service), other mobile devices, or the like.

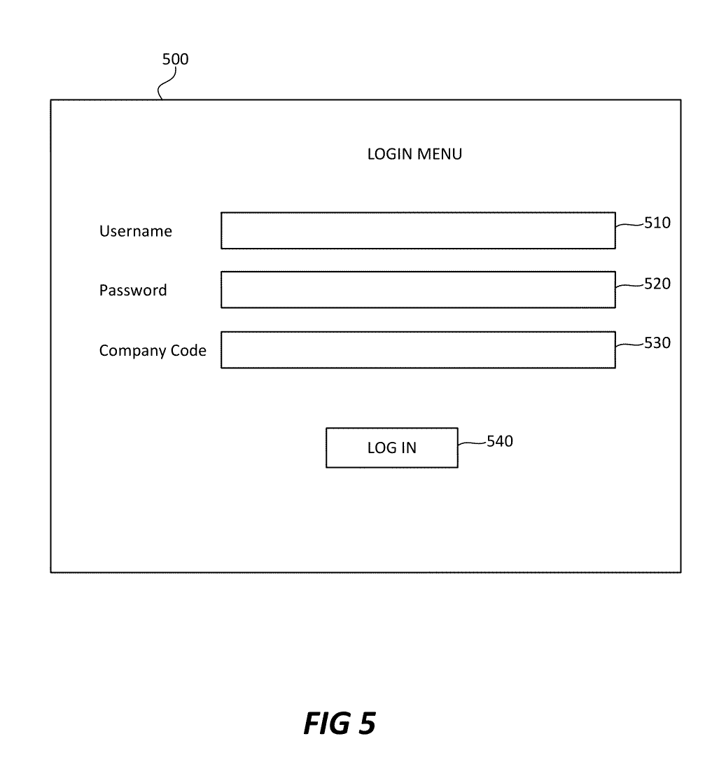

The mobile devices 150 may be configured to authenticate the associated user before the user is allowed to interface with the application embodying the staff management system 100. For example, the application interface executed on the mobile device 150 may require the user to complete a login procedure. Referring to FIGS. 1-5, the mobile device 150 may display a login interface 500 to the user through the display device 330 of the mobile device 150. In some embodiments, the login interface 500 may be initiated and displayed when the user indicates a desire to use the staff management application on the mobile device 150 by perform actions such as, but not limited to, selecting a user-selectable icon representing the staff management application through the user input device 340 of the mobile device 150. As shown in FIG. 5, the login interface 500 may include a username section 510, a password section 520, a company code section 530, and a login element 540. The username section 510, the password section 520, and the company code section 530 may each include a text field (or other interactive elements that may receive text and voice input from the user, such as an element for enabling voice commands) for receiving input that specifies a user name for receiving a username, password, and/or a company code. The login element 540 may be selected by the user to start a login process in which the username entered in the username section 510, the password entered in the password section 520, and the company code entered in the company code section 540 may be authenticated by the mobile device 150, the backend device 110, and/or other suitable devices, as described.

In some embodiments, the username, password, and company code may be transmitted, via the network 130, to the backend device 110 to be used in the authentication process at the backend device 110. The backend device 110 may be configured to execute a computer program in response to receiving of the username, password, and company code, to verify that the username, password, and a company code (along or in combination) are valid login credentials. In a case where at least one of the username, password, and company code is invalid, the backend device 110 may send an indication to the mobile device 150, and the mobile device 150 may prompt the user in any suitable manner through the display device 330 for further user input. In a case where the credentials are verified, then the backend device 110 may grant the user access to use the staff management application on the mobile device 150 and allow the mobile device 150 to connect to the backend device 110 for data communication (e.g., data downloading and/or uploading). In other embodiments, the mobile device 150 (the particular one on which the user attempts to log in, or another mobile device 150 that is separate from the particular one) or a client device 140 may perform the user authentication (locally or via the network 130) with the username, password, and company code entered by the user. Thus, the login process described may provide authentication protection against unauthorized use.

In the event that at least one of the username, password, and company code is not available to the user (e.g., the user forgets), the command center in which the backend 110 is located may generate a temporary password. The temporary password may be generated by personnel associated with the command center or by the backend device 110 under operation of the personnel. The staff management application may, then, allow the temporary password to be associated with the user for at least a period of time (e.g., for 9 hours, or for until the old password is reset) for temporary user authentication the purposes. In other embodiments, the login interface 500 may provide a user-selectable element that, when selected via the user input device 340 of the mobile device 150, the mobile device 150 may send a request to the backend device 110, indicating that a user has forgotten at least one of the login credentials. The backend device 110 may then allow the user to be authenticated through other types of authentication, and/or automatically generate a temporary password for the user after the user can sufficiently identifies himself (e.g., through answering security questions, a call/video-call with personnel associated with the command center, and/or the like).

The company code may represent a company, entity, or an organization that the user may be associated with. In further embodiments, the company code may also distinguish subgroups and subdivisions within a single entity. In a given facility, there may be at least one company performing some type of service for the facility. Each company or subgroup within a company may be uniquely identified by the company code in the staff management system 100. In some embodiments, two or more companies may perform separate types service for the facility. In various embodiments, two or more companies may perform a same service for the facility, and the company code for these companies may be the same or different. The companies may include, but not limited to, a security company, a cleaning company, a maintenance company, a medical service provider, an emergency responder, and/or the like.

In some embodiments, each user may be associated with a role. Each role maybe unique to a user, or a plurality of users may share the same role. In some embodiments, the roles may be assigned to the user by the backend device 110 automatically when the user is added to the user database (residing on the memory 220 of the backend device 110 or the database 120), or in the alternative, the roles may be assigned manually by the personnel associated with the backend device 110, and saved into the memory 220 or the database. In further embodiments, the role of each user may change in the course of time depending on management decisions, staff rotation and assignment, the user's location, the time of the day, and/or of the like.

The role of the user may be denoted by the username and/or other login credentials used in the login process. The interface subsequently provided by the staff management application after login may be customized based on the company code and/or the role associated with the user, so that the layout of the interface and the information to be presented to the user may be different depending on the role of the user. In some embodiments, the types of incidents, reports, information, and the like, that may be available to a user may be customized based on the user's role and/or company. In one nonlimiting example, a maintenance staff (having a maintenance role) may receive information related to maintenance requests but not a theft notification, while a security guard (having a security role) may receive a theft notification but not maintenance requests. In further embodiments, at least two mobile devices 150 associated with different roles may receive the same notification. For example, both the maintenance staff and the security guard in the example above may receive notification of a fire emergency evacuation order.

In further embodiments, the role of a user may be associated with or based on the user's current position, anticipated position, and/or the like. For example, a user who may currently be in a position with a predetermined distance from a door may be assigned a “doorman” role. As seen in a non-limiting illustration, in the event of an emergency that evacuation of customers may be in order, the users currently assigned as “doormen” would receive a message based on their role. The message may be instructions regarding opening the door or gate and assist in evacuating the customers in an orderly fashion. In other words, geo-fences may be designed to segment the facility or area based on suitable criteria. Users determined within a first geo-fence may be send or receive messages (and/or BOLOs and emergency messages) of a certain type, while other users not within the first geo-fence may send or receive a different message, or no message at all.

In some embodiments, in addition or alternative to the login credential style of authentication, the user may be authenticated by fingerprint, face recognition, a combination thereof, or the like. In further embodiments, regardless of the type of initial authentication process, the user may be prompted, by the mobile device 150, to input authentication credentials (or perform tasks under other forms of authentication) even after the user had already successfully logged in, but not yet logged out. In some embodiments, any subsequent re-authentication processes (authentication before logging out but after logging in) may require a same or different type of authentication method discussed above. Re-authentication requests may be displayed to the user through the display device 330 of the mobile device 150 periodically, and/or after a triggering event occurs. The triggering event may include, but is not limited to, the user indicating that a break is to be taken, the mobile device 150 being idle for a predetermined period of time (e.g., 5 minutes, 10 minutes, or 15 minutes), the accelerometer indicating that the mobile device 150 has been dropped, and/or the like. Such authentication processes may provide improved level of security and secrecy by providing protect against potential security breaches originating from stolen the mobile device 150 that are analyzed for security information related to the facility contained therein.

In some embodiment, the mobile device 150 may be configured to scan a NFC card or a QR code to identify the user via the NFC/QR scanner 390 of the mobile device 150. As described, the mobile device 150 may include an internal device, e.g., the NFC/QR scanner 390, that may scan a NFC card or a QR code to read the information contained therein. Alternatively or in addition, the mobile device 150 may be operatively connected to an external device that may be configured to read the information contained therein and transmit such information to the mobile device 150 via the network 130 or any other suitable connection. The information stored on the NFC card or the QR code may include, but not limited to, the name (or other forms of identification, such as an ID number) of the user, the associated company code, the role of the user, and/or the like. When the user forgets to bring the NFC card or the QR code, which may be an identification card assigned uniquely to the, the command center may provide a temporary NFC card or QR code for temporary use, provided that the user is sufficiently identified according to other methods described.

In some embodiments, as soon as the login process is completed, and the mobile device 150 may become a dedicated device, i.e., the user may be locked out of using ordinary functions of the mobile device 150, the ordinary functions being functions or applications that are not, or not related to, the staff management application. Examples of the ordinary functions of the mobile device 150 may include, but not limited to, texting, calling, accessing the internet via a network, and of the like. This may minimize the user of the mobile device 150 from distractions of using the mobile device 150 as a personal device while at work. In addition, if the user desires to communicate with others or use the internet during work hours for personal reasons (e.g., for an emergency), the backend device 110 may tracks such usage of the mobile device 150 by receiving data from the mobile device 150 related to such usage. For example, the backend device 110 may be configured to extract or otherwise receive information related to usage of network resources for applications that are not related to the staff management application by tracking network resource usage of the mobile device 110. In another example, the backend device 110 may track what applications are being accessed while the mobile device 110 is logged in. This allows the management (e.g., the personnel associated with the backend device 110) to monitor unauthorized personal usage and take necessary measures if the user's usage is beyond the scope of allowable use as set forth in an employment policy, rulebook, and/or the like.

In particular embodiments, once the login process is completed, and the user is logged in, the mobile device 150 may automatically initiate a “lockout” process that disallows the user from accessing other functions or applications of the mobile device 150. In one example, the mobile device 150 does not provide an “exit” feature which would allow the user to exit (or temporarily switch to another application while the staff management application is still running) from the staff management application. In some embodiments, the user may access other applications/functions of the mobile device 150 by logging out of the management tool (according to logout procedures disclosed herein) or inputting a second set of authentication credentials (e.g., a username/password combination). The second set of authentication credentials may be the login credentials of the user or an administrative credential that is different from the user credential. In other embodiments, the user may use other functions or applications of the mobile device 150, i.e., the mobile device 150 does not become a dedicated device after logging in. In this embodiment, the backend device 110 may record usage of the mobile device and transmit the recorded information to the backend device 110 as described.

In some embodiments, the mobile device 150 may allow the user to communicate with personal contacts through a voice call, video call, or a text message, where the personal contacts may be imported into the staff management application interface such that even when the mobile device 150 becomes a dedicated device, the personal contracts can be made available to the user. The information related to usage of such features may be saved and/or sent to the backend device 110 through the network 130 for monitoring in the manner described. Accordingly, by enabling such feature, the staff management system may be implemented on a device personal to the user (i.e., the mobile device 150 may be for personal use during off-hours and for work-related activities during work hours), such that a single device may suffice for both types of uses. In further embodiments, payroll data (e.g., data related to work hours of the user as described in this application) may be made available to personal finance applications of the mobile device 150, such that payment or deduction information and transactions may be directly imported to the personal finance applications from the staff management application described herein.

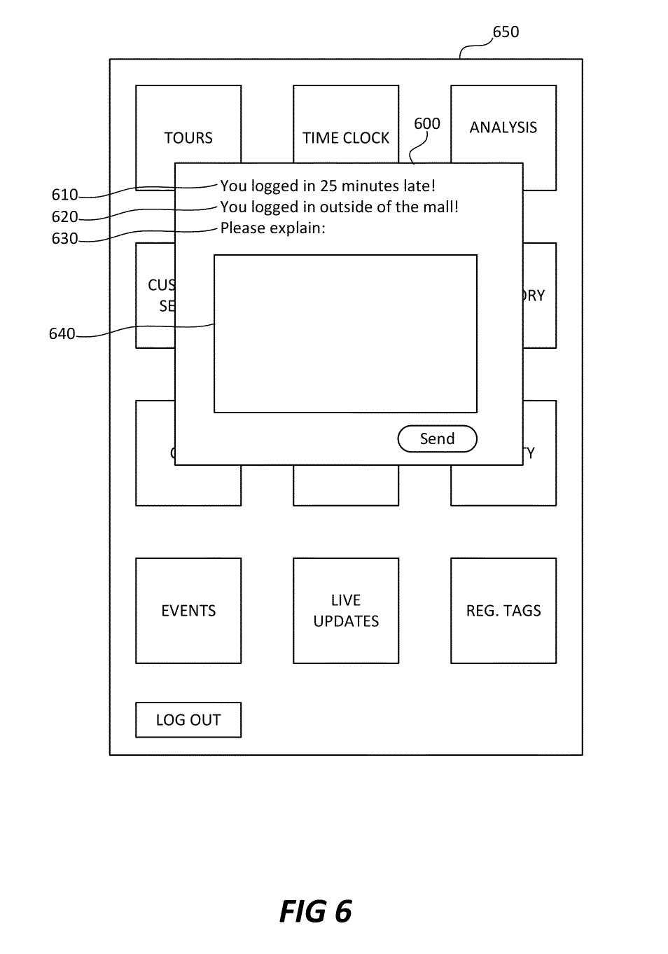

Now referring to FIGS. 1-6, illustrated is a diagram representing an example of a window interface 600 according to various embodiments. The mobile device 150 may be configured to provide the user associated with the mobile device 150 with a message field 640 configured to receive text inputted by the user when the user does not log in at an appropriate time or location. In other words, the window interface 600 may be displayed to the user in response to the user not logging in within a predetermined time period or the user not logging in within a predetermined geological boundaries. The mobile device 150 may be configured to notify the users the reasons for which the user may be required to input explanation, e.g., by displaying a time-related notification 610 stating that the user has not logged in within a predetermined period of time, or a location-related notification 620 stating that the user has logged in outside of the predetermined area. The mobile device 150 may prompt the user to explain by providing request 630 for prompting the user to input reasons. In some embodiments, the window interface 600 may be a popup window which may be laid over the top of the user interface 650 being displayed by the staff management application.

In some embodiments, the backend device 110 may access a set of user login rules, which may include the time period and/or location boundaries in which the user may be required to log in. The backend device 110 may determine, based on the user login rules, whether the user has logged in within the predetermined period of time or within the predetermined boundaries. In other embodiments, the client device 140 and/or another mobile device 150 may access the user login rules and perform the determination. The user login rules may be stored in the memory 320 of the mobile device 150 associated with the user, in the memory 220 of the backend device 110, the memory 420 of the client device 140, or the database 120, where whether the user has logged at the appropriate time or location may be determined. In the case that the user login rules are not stored on the entity which performs the determination, the user login rules may be transmitted to the determining device via the network 130 in response to the user's login attempt (e.g., when the device that stores the user login rules receives an indication that the user is attempting to log in).

In some embodiments, as soon as the user logs in through the mobile device 150 after performing various authentication tasks described, a login request may be sent to the backend device 110. In some embodiments, the mobile device 150 may add a time stamp to the login request sent to the backend device 110 (also the client device 140 and/or another mobile device 150) for the backend device 110 (the client device 140, or another mobile device 150) to determine whether the user had logged in within the predetermined period of time. The time stamp may be generated by the timer device 380 of the mobile device 150. The determination of tardiness or early arrival is made, based at least in part on, the predetermined time period as specified by the rules described above and the time stamp, alone or in combination. Whereas the mobile device 150 is not configured to send a time stamp to the determining device, the determining device may use its own timer to perform such determination.

In further embodiments, the mobile device 150 may add geo-location data of the mobile device 150 to the login request to the backend device 110. The geo-location data may be an ascertained location of the mobile device 150 and/or raw location data that may require computation of the backend device.

When a login request is received by the backend device 110 within the predetermined period of time and/or within a predetermined boundaries, the backend device 110 may send a validation to the mobile device 150 indicating a successful authentication. On the other hand, when a login request is not received by the backend device 110 within the predetermined time period and/or within the predetermined boundaries, then the backend device 110 may send a restriction that restricts the user from access any features of the staff management application through the mobile device 150 unless the user provides an explanation in response to the user's login attempt. Such explanation may be related to why the user does not log in according to the user login rules. In some embodiment, login credentials may only be authenticated when the user logs in within the predetermined time period and the predetermined boundaries. In other embodiments, login credentials may be authenticated when the user logs in within either the predetermined period of time or the predetermined boundaries.

Data related to the explanation composed by the user and the time/location where the login occurred may be sent, via the network 130, to the backend device 110 to be displayed to personnel associated with the backend device 110 (e.g., any administrative staff) and stored by the backend device 110 (in the memory 220 or the database 120). In some embodiments, the data related to the user's login patterns (including but not limited to, the time and the location of the login attempts and the explanation of inappropriate login attempts) may be stored on the memory 220 of the backend device 110 and/or the database 120 for further analysis. The backend device 110 may be configured to aggregate data related to each user over a period of time, such that algorithms, such as compensation algorithms may be applied based on such data. In some embodiments, the backend device 110 may be configured to generate tours for each user based, at least in part, on the information related to the user's login practices. Accordingly, the management may analyze workforce fluctuation, adjust compensation, and perform other similar analysis based on such information, thus simplifying information gathering regarding staff members who may be dispersed across a facility.

By way of illustrating with a non-limiting example, a security guard for a mall facility may be scheduled to log in at 9 a.m. Monday through Friday, the predetermined period of time may be set (by a designated administrative staff or by the backend device 110 automatically) to be 5 minutes before or after 9 a.m. (e.g., between 8:55 a.m. and 9:05 a.m.). If the security guard in this example logs in before 8:55 a.m. or after 9:05 a.m. (e.g., at 9:25), the backend device 110 may cause the mobile device 150 to display to the user, through the display device 330 of the mobile device 150, a message stating that login occurred outside the designated time period, and provide a text field for the user to enter text explaining his tardiness. In addition, the security guard may be designated to login within the walls of the mall, and the geo-location data may indicate that the security guard's login attempt occurred in the parking lot of the mall (e.g., to avoid further tardiness by reducing the time it will take him to walk into the building). In that case, the backend device 110 may cause the mobile device 150 to display to the user, through the display device 330 of the mobile device 150, a message stating that login occurred outside of the designated boundaries, and provide a text field for the user to explain. In some embodiments, the text field for explaining tardiness/early arrival may be the same text field as the text field for explaining logging in outside of the predetermined boundaries. In other embodiments, the mobile device 150 may be configured to present two separate text fields to the user, one for tardiness/early arrival, and another for undesignated location.

Once logged in, the mobile device 150 may be configured to undergo a live update of data. In some embodiments, the backend device 110 may initiate the update by sending update data over the network 130 to the mobile device 150 in response to successful login of the user. In other embodiment mobile device 150 may be configured to send a update request to the backend device 110, and the backend device 110 may send the update data to the mobile device 150 in response to the update request. In various embodiments, data may not be stored on the mobile device 150, and the mobile device 150 may access data either through the live update (the data received may be stored temporarily on the memory 320 of the mobile device 150 until logout) and/or request to retrieve particular data from the backend device 110 based on need. The data may be deleted in response to a user logging out the application. In other embodiments, data may be stored on the mobile device 150 even after the logout, and may be updated during the live update. The update data may include software update data, administrative messages, “be on the lookout” (“BOLO”) messages, tour instructions, schedules, and/or the like. In particular embodiments, BOLO messages may be contain information related to a matter that requires the user to maintain surveillance for, and may have a predetermined expiration date, and may be deleted automatically from the mobile device if on the expiration date.

Referring to FIGS. 1-7, illustrated is an example of a selection interface 700, in the form of a display screen for a touch screen display device. The selection interface 700 may include a plurality of user interactive elements 701-712 (such as touch locations, buttons, or click locations) for selecting from among a corresponding plurality of operations, each represented by a separate user interactive element 701-712. In some embodiments, the selection interface may be configured to be presented to the user, by the mobile device 150 via the display device 330, after a successful login authentication as described. In further embodiments, the selection interface 700 may include a tour management element 701, time clock element 702, analysis element 703, customer service element 704, incident response element 705, inventory management element 706, CCTV 707, reports and message element 708, facility element 709, events element 710, live update element 711, and check point tag element 712. Furthermore, the selection interface 700 may include a logout element 713, configured as a user interactive element representing a logout operation, which may be configured to trigger the logout process when selected by the user. In some embodiments, a logout process may include sending a logout indication, a time stamp representing time of logout, and/or a geo-location of the mobile device 150 at the time of logout. In further embodiments, the mobile device 150 may be configured to erase data used during operation of the staff management application, the data may include messages or instructions, tour data, schedule data, BOLO messages, and/or other suitable data sent to the mobile device 150.

The user may log out from the staff management application by selecting a logout element 713, configured as a user interactive element selectable by the user through a touch, a click, or the like. In some embodiments, the logout element 713 may include a touch location denoting “logout,” “check out,” or the like. The mobile device 150 may be configured to log the user off in response to the user scanning an ID card (e.g., a NFC card or a QR code card that may be used for login). In some embodiments, the mobile device 150 may be configured to display a prompt to the user and request for validation from the user that logout is desired by the user of the mobile device 150.

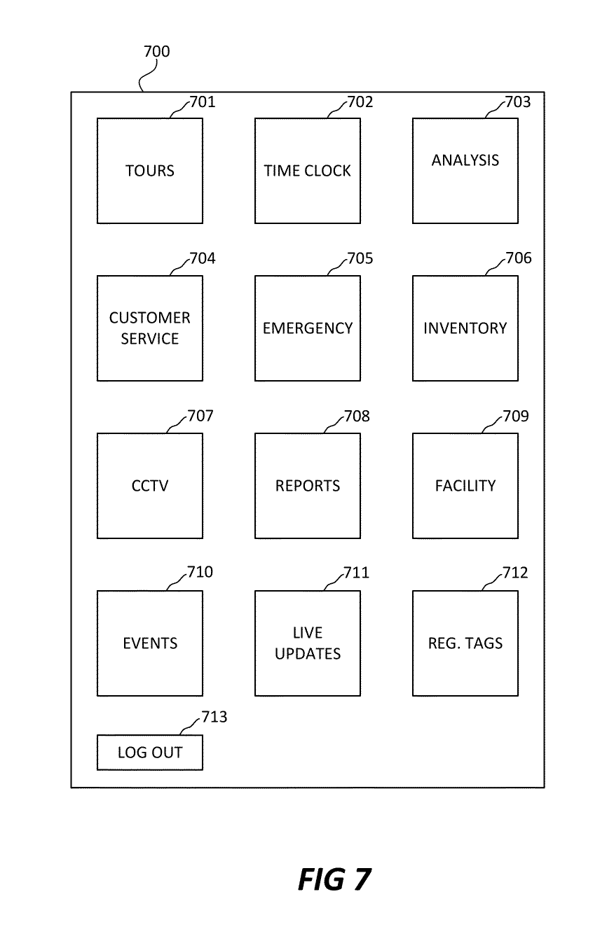

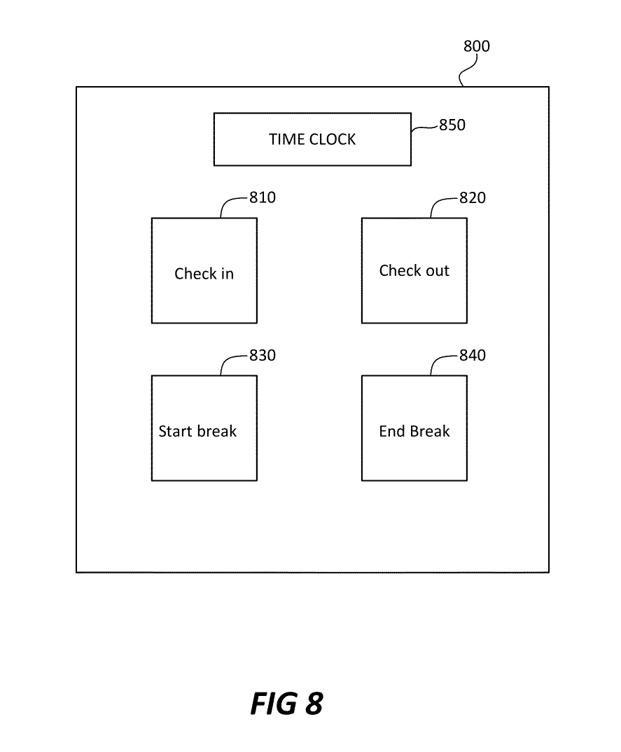

Referring to FIGS. 1-8, an example of a time clock management interface 800 is hown in FIG. 8, in the form of a display screen of the mobile device 150 according to various embodiments. The time clock management interface 800 may include a check-in element 810, a check-out element 820, start-break element 830, end-break element 840, and time clock display 850. The time clock management interface 800 may be presented to the user in response to (or otherwise after) the user selecting the time clock element 702 of FIG. 7. Once the user successfully logs in, he may check in by selecting the check-in element 810 to indicate that the user is about to begin a tour. In some embodiments, a tour may be initiated in response to the user selecting the check-in element 810, or in response to the user selects the tour management element 701 shown in FIG. 7. The mobile device 150 may be configured to send the backend device an indication indicating that the user has checked in or checked out in response to the user selecting the check-in element 810 or the check-out element 820, respectively. The user may select the check-out element 820 to end the tour. The mobile device 150 may be further configured to send an indication to the backend device 110, indicating that the user has started a break or ended a break by selecting the start-break element 830 and the end-break element 840, respectively. The time clock display 850 may be configured to display a lapse time since the user started the tour, a lapse time since the user started the break, a time remaining for the tour and/or the break, or a combination thereof.

In some embodiments, in response to the user selecting the checking-out element 820, the mobile device 150 may send a checkout indication to the backend device 110, the checkout indication may include identifying information of the user associated with the mobile device 150, a time stamp indicating the time of checkout, and/or a geo-location data indicating the location of the mobile device 150 at the time of checkout. The backend device 110 may display the identity of the user, the time stamp, and the geo-location to the personnel associated with the backend device 110, e.g., a manager, to approve the checkout/log out. In further embodiments, the backend device 110 may store such data in the memory 220 and/or the database 120 for further reference, or analyzing the user's logout patterns.

In some embodiments, the mobile device 150 may be configured to present a message to the user when the user does not take a break within a predetermined period of time, the message may be configured to prompt the user to take a break or request the user to input explanation as to why the break is not taken at the appropriate time. In some embodiments, when the backend device 110 does not receive an indication that the user has started a break within a predetermined period of time, the backend device 110 may send a break indication to the mobile device 150, instructing the mobile device 150 to present a notice to the user in response to the indication sent by the backend device 110. The predetermined period of time may be determined manually by a designated personnel or automatically by a device, e.g., the backend device 110, and stored in the memory 320 or the database 120. In other embodiments, the mobile device 150 may store such schedule, and may itself present the notice when the mobile device 150 itself determines, based on the schedule, that the user has not taken a break within the predetermined period of time. The notice may be dismissible by the user without inputting a reason (by allowing the user to exist the window interface in which the notice is being displayed), or in the alternative, the notice may not be dismissible such that the staff management application cannot be used by the user until the user inputs, or the text inputted is approved by the backend device 110. The notice may include a text field for the user to input an text representing an explanation as to the cause of the user not taking a break at the appropriate time. The inputted text data may be sent, via the network 130, to the backend device 110. The backend device 110 may approve the user associated with the mobile device 150 not taking break within the predetermined period of time, or send a second notification to the mobile device 150, prompting the user to take the break.

In further embodiments, the mobile device 150 may be configured to present a notice to the user when the user is about to begin over time or double time work. The notice may include a message notifying overtime or double time work is imminent, and a user interactive element may be presented to the user for acknowledging the notice. In some embodiments, in response to the user acknowledges the notice, the mobile device 150 may be configured to send a request to the backend device 110 for approval. The backend device 110 may automatically approve such request and send an affirmation to the mobile device 150, or in the alternative, the backend device 110 may present such information, in the form of text or other suitable means displayed on the display device 230, to the designated personnel associated with the backend device 110 for approval, and send the affirmation to the mobile device 150 once approved by the designated personnel.

In still further embodiments, when the mobile device 150 logged or checked into more staff management application for more than a predetermined period of time (e.g., 8 hours, 10 hours, and/or 12 hours), the mobile device 150 may be configured to present, via the display device 330 of the mobile device 150, an inquiry for determining whether the user is still actively with the staff management application. The mobile device 150 may be configured to present a user interactive element to allow the user to acknowledge that the user is still logged in or checked in. In some embodiment, the user may be presented a text field and/or other suitable communication interface such as a voice call element that allow the user to input explanation to the backend device 110 as to the reason causing the user to be still logged in at the time.

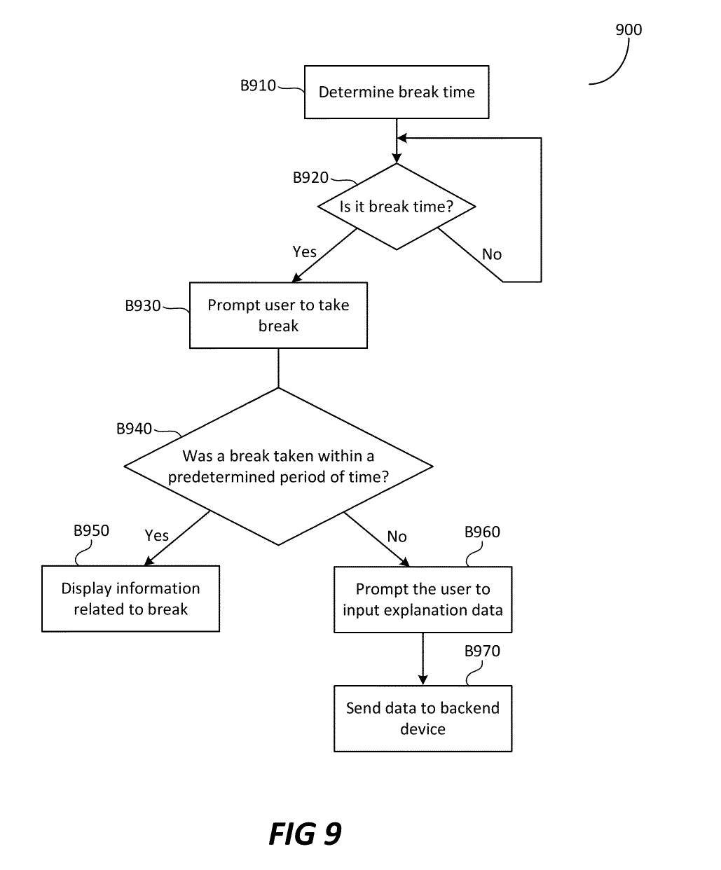

FIG. 9 is a process flow chart illustrating a method for time clock management of starting a break in accordance with various embodiments. At block B910, a break time (and a predetermined period of time encompassing the break time) in the form of a schedule may be determined. In some embodiments, the schedule may be determined manually by a designated personnel associated with the backend device 110, or automatically by a device, e.g., the backend device 110, and stored in the memory 320 of the backend device 110 or the database 120. The determined schedule may be transmitted to the mobile device 150. In other embodiments, the mobile device 150 may store such schedule, and may determine the predetermined period of time based on the schedule. In further embodiments, the schedule may be generated based on the role of the user associated with the mobile device 150. The schedule may be valid for a preset amount of time (e.g., a generated schedule may be valid for a day, a week, or a month) before the schedule is regenerated and updated.

Next at block B920, a determination may be made as to whether it is time for a break, i.e., whether the current time is a scheduled time to take a break according to the schedule described. In some embodiments, the backend device 110 may compare the current time (from its own clock or from the timer device 380 of the mobile device 150) with the scheduled time. In other embodiments, the mobile device 150 (or other devices such as the client device 140 or another mobile device 150) may compare the current time obtained by the timer device 380 with the scheduled time. If it is determined that it is not a time for a break, then the process returns to block B920 to assess, again, whether it is time for a break.

If it is determined that it is time for a break, then next at block 930, the mobile device 150 may prompt the user to take a break by displaying, via the display device 330 of the mobile device 150, a notification to the user prompting the user to take a break. In some embodiments, the notification may be presented with a user interactive element configured allow the user to indicate starting of a break. The notification may be presented in a popup window with audio alert, vibration alert, or visual alert, and/or the like to attract the user's attention. In other embodiments, the notification may be a voice notification that may be played (automatically, with or without the user's authorization) by the mobile device 150.

Next at block B940, the mobile device 150 and/or the backend device 110 may be configured to determine whether a break was taken within a predetermined period of time following the scheduled time for the break (or a period of time spanning from before the scheduled break and/or after the schedule break) by, for example, determining whether a break indication is received by the backend device 110 within a predetermined period following the scheduled time. In some embodiments, the mobile device 150, upon receiving the break indication via the user input device 340, may find that the break was taken within the predetermined period of time. When no break indication is received at the end of the predetermined period of time, the mobile device 150 may determine that no break was taken within the predetermined period of time. Alternatively, the backend device 110 may receive the break indication from the mobile device 150, and determine whether a break was taken within the predetermined period of time.

If the break is determined to be taken within the predetermined period of time, then next at block B950, the mobile device may be configured to display information related to the break. Such information may include, but not limited to, the time elapsed since the beginning of the break, time remaining on the break, the location of the mobile device 150 during the break, and/or the like. The information may be retrieved or otherwise received from the backend device 110 in response to the break indication, or information may be generated by the mobile device 150 locally.

If no break taken within the predetermined period of time, then at block B960, the mobile device 150 may present a notification to the user notifying that a break was not taken, and/or present a user with an interactive element for the user to input explanation as to why a break was not taken, as described. Next at block B970, the mobile device 150 may send data including, but not limited to, the user's input, a time stamp, and a geo-location of the backend device 110, to the backend device 110. The backend device 110 may display such data (with visual display or audio) to the personnel associated with the backend device 110, either automatically when received or at the discretion of the personnel. The backend device 110 may store such information on the memory 220 of the backend device 110 or the database 120 for records or further analysis.

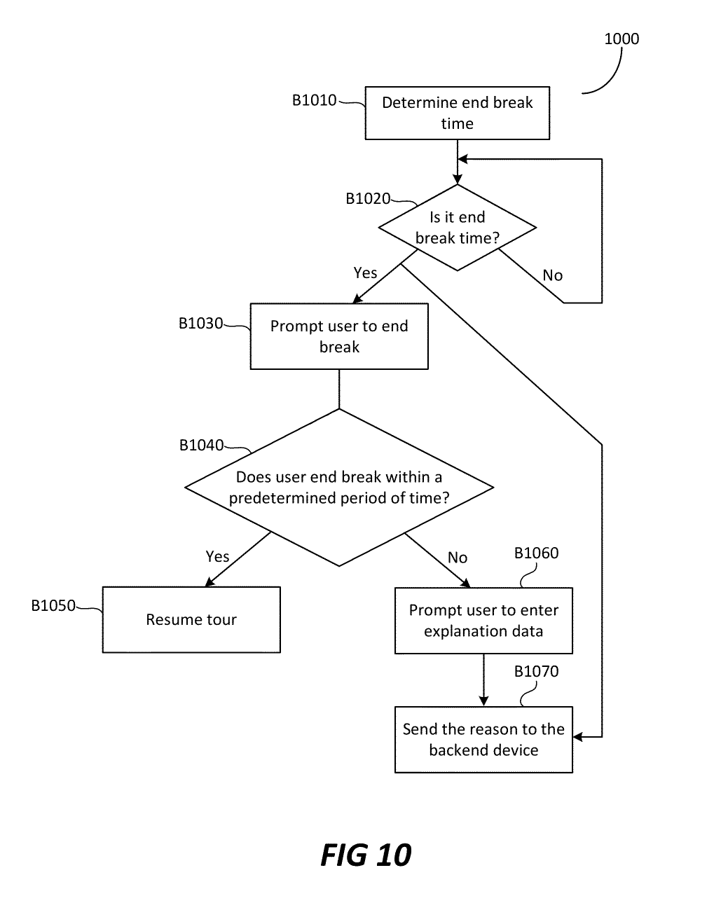

Referring to FIG. 10, illustrated is a process flow chart illustrating a process 1000 for implementing time clock management of ending a break in accordance with various embodiments. At block B1010, an end break time (e.g., the time after the lapsing of a preset period of time following the start break time) may be determined. The end break time may be a any suitable amount of time after the start break time, including, but not limited to, 5 minutes, 10 minutes, and 15 minutes after the start break time. Alternatively, the end break time may be a time set irrespective of the start break time. In some embodiments, the end break time (in the form of a schedule) may be determined manually by a designated personnel or automatically by a device, e.g., the backend device 110, and stored in the memory 320 or the database 120. In further embodiments, the end break time may then be sent to the mobile device 150 after being generated. In other embodiments, the mobile device 150 may store such schedule, and may determine the end break time based on the schedule.

Next at block B1020, a determination may be made as to whether the current time is the end break time. In some embodiments, the backend device 110 may compare current time (from its own clock or from the timer device 380 of the mobile device 150) with the end break time. In other embodiments, the mobile device 150 (or other devices such as the client device 140 or another mobile device 150) may compare the current time obtained by the timer device 380 with the end break time. If it is determined that it is not the end break time, then the process 100 may return to block B1020 to assess, again, whether it is the end break time.

If it is determined that it is end break time, then next at block 1030, the mobile device 150 may prompt the user to end the break by displaying, via the display device 330 of the mobile device 150, a notification that the break has, or about to, end. In some embodiments, the notification may be presented with a user interactive element configured to indicate to the mobile device 150 and/or the backend device 110 that the break has needed, when selected or otherwise activated by the user. The notification may be presented in a text window with a sound, vibration, flashing of the light, and/or the like to attract the user's attention. The notification may be presented in a popup window with audio alert, vibration alert, or visual alert, and/or the like to attract the user's attention. In other embodiments, the notification may be a voice notification that may be played (automatically, with or without the user's authorization) by the mobile device 150.

Next at block B1040, the mobile device 150 and/or the backend device 110 may be configured to determine whether the break has ended within a predetermined period of time following the end break time (or a period of time spanning from before the end break time and/or after the end break time), by, for example, determining whether an end break indication was received within that predetermined period time. In some embodiments, the predetermined period of time may refer to a period of after the notification to end the break has been sent to the user indicating that the break is ending or about to end. In some embodiments, the mobile device 150, upon receiving user input indicating ending the break via the user input device 340, may find that the break has ended within the predetermined period of time. When no user input is received at the end of the predetermined period of time, the mobile device 150 may determine that the break has not ended within the predetermined period of time. Alternatively, the backend device 110 may receive an end break indication from the mobile device 150, and determine whether a break was ended within the predetermined period of time based on the time that the backend device 110 received the end break indication from the mobile device 150.

If the break is determined to be taken within the predetermined period of time, then next at block B1050, the mobile device 150 may be configured to resume the tour. When the break is not ended within the predetermined period of time, e.g., if the break is ended before a designated period of time or extends beyond the end time by a designated period of time, then at block B1060, the mobile device 150 may present a notification to the user notifying that the break has not ended appropriately, and/or present the user with an interactive element (e.g., a text field, a voice input) for the user to explain the cause of the break was not ending. Next at block B1070, the mobile device 150 may send data including, but not limited to, the user's input, a time stamp, and a geo-location of the backend device 110, to the backend device 110. The backend device 110 may display such data (with visual display or audio) to the personnel associated with the backend device 110, either automatically when received or at the discretion of the personnel. The backend device 110 may store such information on the memory 220 of the backend device 110 or the database 120 for records or further analysis.

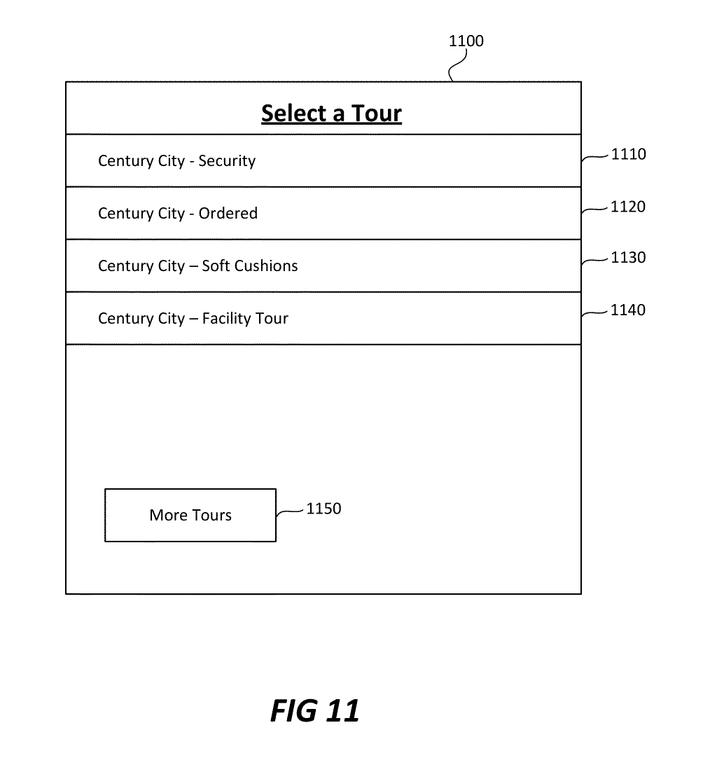

Referring to FIGS. 1-11, the mobile device may be configured to provide the user with tour management feature, for example, if the tour management element 701 is activated by the user by any suitable means described. In particular embodiments, the mobile device 150 may be configured to present a tour selection interface 1100 to the user, as illustrated by FIG. 11. In some embodiment, the mobile device 150 may be configured to display a list of available tours 1110-1140 that the associated user may undertake. By illustrating with a nonlimiting example, the available tours may be titled “Century City—Security” 1110, “Century City—Ordered” 1120, “Century City—Soft Cushions” 1130, and “Century City—Facility” 1140. Each available tour and the corresponding tour information may be stored in the memory 320 of the mobile device 150, or in the alternative, may be stored on the memory 220 and the database 120 such that the data related to each tour may be transmitted to the mobile device 150 during the live update or in response to the indication of the user to use the tour feature, e.g., by selecting the tour management element 701. The mobile device 150 may be configured to present an additional tour element 1150 that would retrieve additional tours when selected by the user. In some embodiments, the additional tour element 1150 may provide for viewing of additional tours that may not be supported by the display device 230 of the mobile device 150 given the set size of the display device 230. In further embodiments, the additional tour element 1150 may provide viewing of additional tours that may be less relevant for the user, e.g., tours that may not be presented to the user on the first page of the tour selection interface 1100 because they may be less relevant in some aspect, e.g., the additional tours may not correspond to the role of the user, or the additional tours may not be generated for the time of the week. The additional tours may be stored on the memory 220 or the database 120 associated with backend device 110, or in the alternative, on the memory 320 of the mobile device 150.

The mobile device 150 may be configured to display the list of available tours 1110-1140 based on the role of the user. For example, a user who is a security guard may be presented with tours that related to patrolling the facility, while a user who is a cleaning crew member may be presented with tours related to locations that need to be cleaned, and/or the like. In further embodiments, the details of the tours (such as checkpoints setup, instructions, tasks, and action items as described) may be customizable based on the role of the user. In other embodiments, the mobile device 150 may be configured to display a list of all available tours for a same facility (irrespective of the role of the user) for the user to select. In still other embodiments, the available tours (or a single tour) may be selected by the backend device 110 or the mobile device 150 based on a set of predetermined algorithms automatically, or by the designated personnel associated with the backend device 110.

Each tour may be a timed tour, an ordered tour, a random tour, an open tour, a combination thereof, or the like. A timed tour may specify the time required for the user to complete the entire tour and/or the time interval between each checkpoint (or each task) of the tour. In some embodiments, the mobile device 150 may be configured to alert the user (through the user notification device 370) if the user does not spend as long as a predetermined time interval between two or more checkpoints in the tour, or if the user spends longer than the predetermined time interval between two or more checkpoints in the tour. In further embodiments, the mobile device 150 may be configured to alert the user (through the user notification device 370) at a predetermined amount of time before the end of the tour. In still further embodiments, the user may be required to input a message explaining the cause of not spending the appropriate amount of time as specified in a manner similar to described with respect to the start-break and end break-features.

In some embodiments, the mobile device 150 may initiate an ordered tour, which may specify a list of locations (each location may be associated with at least one checkpoint) that the user must visiting in order specified. In further embodiments, a tour may be both timed and ordered, e.g., the tour may specify an list of locations that the user must visit in order, and a predetermined time interval between two or more of the locations may be set.

In various embodiments, the tour may be random, i.e., the order of the locations to be visited may be determined randomly by the mobile device 150 or the backend device 110. The randomization process may occur during live update, when the user checks in or logs in, or when the random tour is selected, either by the user or the backend device. Consequently, the user must visit the locations in the order specified by the randomization process. In further embodiments, a tour may be both timed and random, e.g., the order of the locations to be visited may be generated randomly in the manner described, and a predetermined time interval between two or more of the checkpoints may be set.

In some embodiments, the mobile device 150 may initiate an open tour, which does not specify an order according to which the user must visit a list of predetermined locations. The user may or may not be provided with a list of locations to visit. In some embodiments, the user may be given a list of locations to be visited, but may be free to choose the order in which these locations are visited. In some embodiments, an overall time period may be specified for such open tour. In further embodiments, a tour may be both an open tour and a timed tour, e.g., the user may be free to visit locations in no particular order in the manner described, and a predetermined time interval between two or more of the checkpoints may be set.

A tour may be defined with respect to geological locations, such as but not limited to, a tour that relates to at least one room or store in a facility, at least one floor of the facility, or a section of the facility, the entire facility (as shown in the example set forth by FIG. 11, Century City—Facility Tour 1140), combination thereof, and/or of the like. In addition, a tour may be defined with respect to the role associated with the user of the mobile device 150 who may be taking the tour. The tours defined with respect to roles may include, but not limited to, a tour for security guards (as shown in the example set forth by FIG. 11, Century City—Security 1110), a tour for engineers, a tour for cleaning crew, a combination thereof, and/or of the like. Furthermore, a tour may be defined with respect to the purpose or nature of the tour, such as, but not limited to, a tour for inspecting a type of items or locations (as shown in the example set forth by FIG. 11, Century City—Soft Cushions 1130), a tour for checking all bathrooms, a tour for checking proper closing of combination thereof, and/or of the like. In various embodiments, each tour may be one or more of an ordered tour, a timed tour, a random tour, an open tour, a tour based on geological locations, a tour based on a role of a user, and a tour based on a purpose.

Each location may be associated with at least one checkpoint. The checkpoint system may be one described in Provisional Application U.S. Application 61/865,923, filed Aug. 14, 2013, incorporated herein by reference in its entirety. In some embodiments, each checkpoint may include at least one checkpoint tags which may contain pre-stored information related to the checkpoint. When the mobile device 150 in sufficient proximity of a checkpoint tag at that checkpoint location, the mobile device 150 may be configured to scan or otherwise read data from the checkpoint tag, e.g., using magnetic, optical, or other suitable reading electronics in the mobile device 120 and/or wireless fidelity (WiFi), frequency modulation (FM), Bluetooth (BT), near field communication. The reading of the tag may trigger the mobile device 150 to present a form for the user to fill out, obtain messages associated with the checkpoint location, and present a set of instructions to be performed by the user.

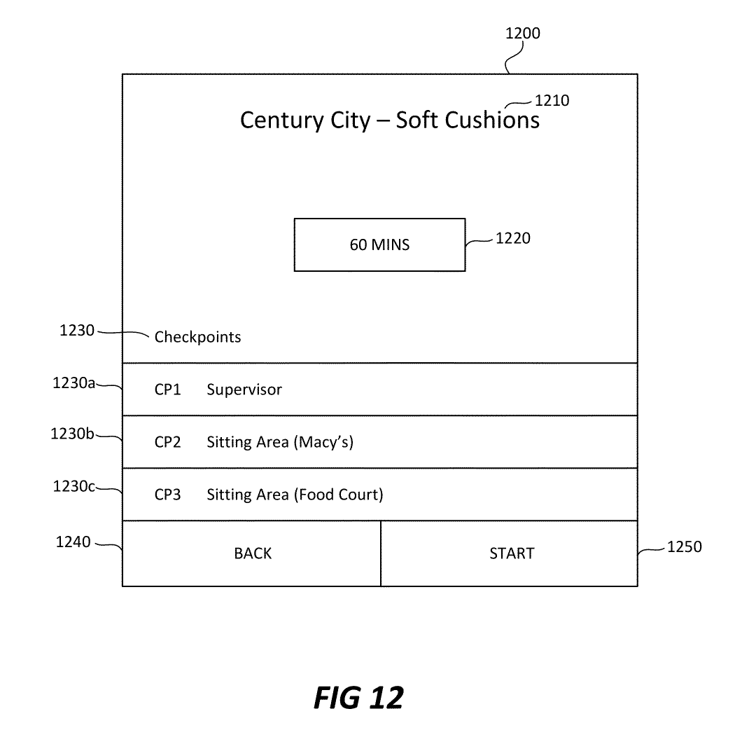

Now referring to FIGS. 1-12, the mobile device 150 may display to the user a tour information overview interface 1200, as illustrated by FIG. 12, according to various embodiments. The tour information overview interface 1200 may be displayed by the mobile device 150 after a tour has been selected by a user in the tour selection interface 1100. In some embodiments, the tour information overview interface 1200 may include a tour name 1210, time display 1220, a checkpoint list 1230 displaying a plurality of check points 1230a-1230c. Each of the plurality of checkpoints 1230a-1230c may include a title and/or concise description that sufficiently identifies the checkpoint to the user. The time display 1220 may be configured to display a period of time in which the tour may be completed in. In further embodiments, a timed tour may include an allotted time (not shown) to complete tasks associated with each checkpoint in the list of checkpoints 1230. In some embodiments, the time display 1220 may be associated with a timed tour as described. In further embodiments, a return element 1240 (represented in FIG. 12 as “BACK”) may be included in the tour information overview interface 1110 for returning to the tour selection interface 1100, and a start element 1250 (represented in FIG. 12 as “START”) for starting the tour selected.

Now referring to FIGS. 1-13, FIG. 13 is a diagram representing an example of a tour interface 1300 according to various embodiments. The tour interface 1300 may be displayed to the user via the display device 330 of the mobile device 150 and include a progress presentation 1310, a progress bar 1320, a time lapse display 1330, at least one checkpoint 1350, 1360, 1380, at least one checkpoint completion indicium 1340, a task window 1370, and a task indicium 1390.

The progress presentation 1310 may display an alphanumeric text representing the current progress of the tour as compared to completion of the tour, e.g., a percentage denoting the progress of the tour, where 100% progress may represent completion. The progress of the tour may refer to the number of checkpoints 1350, 1360, 1380 visited (and completed tasks associated with each visited checkpoint) out of the total number of checkpoints included in the tour. In some embodiments, the number of checkpoints visited and the total number of checkpoints may be displayed instead or in addition to the percentage described. In further embodiments, the progress of the tour may refer to the time elapsed since the beginning of the tour out of the total time period required to complete the tour in, e.g., for a timed tour. The progress may further be represented graphically to the user by a diagram which may indicate one or more of completion of the tour, progress made, and progress yet to be made for a tour. In some embodiments, the diagram may include a progress bar 1320, with a shaded (or otherwise colored) portion of the progress bar 1320 indicating progress made, the unshaded (or otherwise uncolored) portion of the progress bar 1320 indicating progress yet to be made, and the entire progress bar 1320 represent completion.

In further embodiments, the tour interface 1300 may include the time lapse display 1330 for displaying the time elapsed since the beginning of the tour. In some embodiments, the time lapse display 1330 may be configured to display the total frame within which the tour is to be completed. The time lapsed display 1330 may be displayed in addition to the progress presentation 1310 and the progress bar 1320 when, for example, the progress presentation 1310 or the progress bar 1320 is based on a number of checkpoints. In some embodiment, the time lapse display 1330 may display time remaining on the tour, e.g., a countdown, instead of or in addition to displaying time lapsed.

The tour interface 1300 may include at least one checkpoint 1350, 1360, 1380, each associated with a location in the facility. Each checkpoint may include at least one task associated with the checkpoint, such task may include, but is not limited to, checking in with a designated personnel, observing the location for a predetermined period of time, filling out a form of conditions of the location based on the observation, making a text or voice comment, resetting a designated equipment, observing/checking a piece of equipment (e.g., the status of a fire door, the operation of a light or machine, the status of a fire hose or fire extinguisher, or the like), inventorying a set of designated items, operating a piece of equipment (e.g., turning on or off a light or machine, or the like) inputting sensor data, time information, image data, audio data, and/or the like.

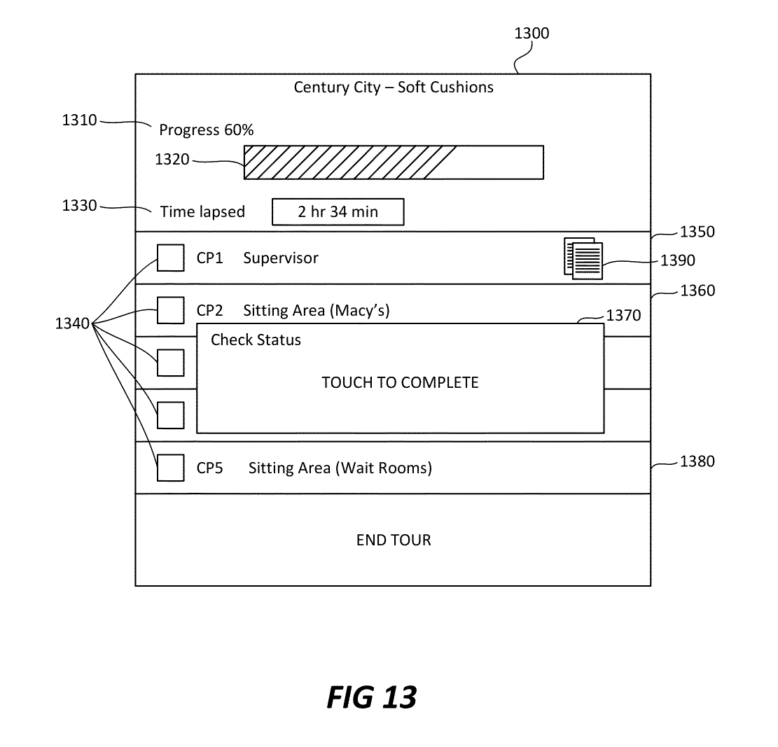

The tour interface 1300 may include at least one task indicium 1390 associated with at least one checkpoint listed in the tour interface 1300, such that when the task indicium 1390 is triggered or otherwise selected, a set of instructions for the corresponding task associated with the checkpoint as well as tools for completing the task (e.g., forms, checklists, confirmation, and text fields) may be presented to the user. In some embodiments, a popup window 1370 containing such instructions and tools may be displayed to the user, and may include instructions (such as check in with the supervisor) and/or a user interactive element indicating a completion of the task, e.g., “touch screen to complete,” as shown in FIG. 13.

In some embodiments, the at least one task instructions and/or tools for completing the task may be presented to the user by the display device 330 of the mobile device 150 in response to the tag associated with the checkpoint location being scanned by the mobile device 150 in the manner described. When a plurality of tasks is associated with the checkpoint, a plurality of task instructions and tools may be presented in any suitable order or manner to the user via the display device 330, including in a drop-down menu, a popup window, or the like. In some embodiments, the user may be presented with a list of tasks, each of which may be indicated by an indicium, and the user may select one indicium to access the instructions and tools for completing the task therein.

Each checkpoint listed in the tour interface 1300 may correspond to a completion indicium 1340. The completion indicium 1340 may be at least one of an alphanumeric text, a code, a drawing, a photograph, a video, the combination thereof, and the like. In some embodiments, the completion indicium 1340 for a checkpoint that has not been visited (i.e., no tasks have been initiated or completed by the user) may appear to be in a first graphical state, e.g., a unchecked stated, of a first color (red, or otherwise colored). In response to a tag being scanned for the first time during the tour or other suitable trigger of the checkpoint, the completion indicium 1340 may appear to be in a second graphical state (e.g., in a filled state, a second color such as yellow, and/or the like) that is different from the first graphical state to illustrate that task performance is underway. In some embodiments, the completion indicium 1340 may appear to be in the second graphical state until all tasks are completed. In response to the completion of every task for the checkpoint, the completion indicium 1340 may appear in a third graphical state (e.g., a check mark, a third color such as green, and/or the like). In further embodiments, a user may not initiate tasks for another checkpoint unless all the tasks for the current checkpoint has been performed.

In some embodiments, when the checkpoint tag is read by the mobile device 150, a tag identification value, a time stamp, and/or geo-location data of the mobile device 150 may be sent to the backend device 110. The backend device 110 may compare the geo-location of the mobile device 150 with a predetermined location of the tag. When the geo-location of the mobile device 150 is within a predetermined distance from the predetermined location of the tag, then the backend device 110 may determine that the tag (and the associated item on which the tag is attached in any suitable manner) has not been moved. When the geo-location of the mobile device 150 is not within a predetermined distance from the predetermined location of the tag, then the backend device 110 may determine that the tag has been moved, and may present such information to the associated personnel of the backend device 110, or instruct the user of the mobile device 150 to move the tag back to its original location by sending the mobile device 150 instruction information to be displayed to the user. The instruction information may include the description of the correct location of the tag and/or a map or photograph that illustrates the correct location of the tag. In some embodiments, each tag may be associated with an inventory item such as, but not limited to, a fire extinguisher, cleaning supplies, and/or the like. The tags may be used in the manner described for geo-fencing purposes in the inventorying of the items.

In particular embodiments, a tag may be placed in or on a vehicle parked or otherwise stopped at a checkpoint location (e.g., a parking space in a parking lot), the tag including data related to the vehicle, such as the identity of the owner, the color of the vehicle, the model of the vehicle, the maker of the vehicle, the year of the vehicle, parking pass expiration date, notable damage, and/or the like. The user associate with the mobile device 150 may scan the vehicle tag and determine, based on the information stored on the vehicle tag (e.g., parking pass expiration date) and the geo-location of the mobile device 150, whether the vehicle is authorized to park at the location where the vehicle tag is scanned. In further embodiments, a task indicium 1390 may be available for vehicle tags, such that the selecting of the task indicium 1390 may cause the mobile device 150 to display a form, the form including various elements for the user to select/input to describe a current condition of the vehicle. For example, where the vehicle has scratches or dents, the user may access the form by selecting the task indicium 1390, the form containing preset selections representing scratches or dents, and/or text fields, voice operators, camera operators for the user to input text, active voice messages, and/or active photographic and video cameras. Completed forms may be transmitted to the backend device 110 for archiving, analysis, and/or the like. In additional embodiments, the task indicium 1390 associated with a vehicle checkpoint may causes a parking violation form to be displayed to the user of the mobile device 150, where the user may input information related to the vehicle's parking violation. The form may be transmitted to the backend device 110 for processing the violation fine.

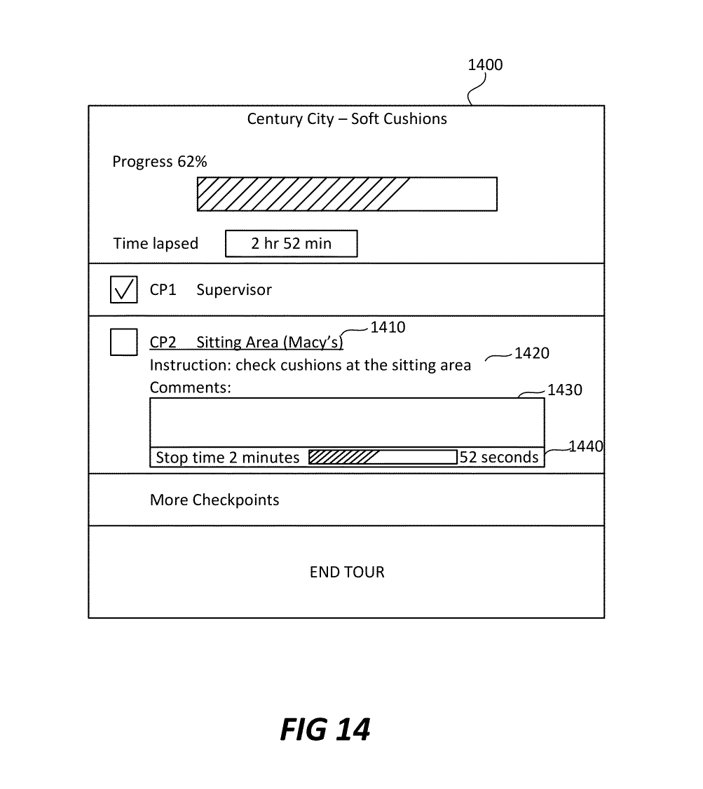

Referring to FIGS. 1-14, another example of a tour interface 1400 is illustrated in FIG. 14 according to various embodiments. In some embodiments, the tour interface 1400 may include, in addition to the features described with respect to FIG. 13, a set of instructions 1420 related to the checkpoint 1410, a user input element 1430, and a timer presentation 1440. In some embodiments, the set of instructions 1420 and the user input element 1430 may be hidden (i.e., not displayed to the user) when the task associated the set of instructions 1420 and the user input element 1430 have not been initiated. The set of instructions 1420 and the user input element 1430 may appear (in a drop-down menu) when the task for the checkpoint 1410 is be initiated, e.g., after the mobile device 150 scanning the tag associated with the checkpoint. In some embodiments, the user input element 1430 may be a text field in which the user may input text, while in other embodiments, the user input element 1430 may be a voice input element that enables voice input, and/or a camera activation element that activates a camera. In some embodiments, the timer presentation 1440 may be configured to display time elapsed and/or time remaining for user to perform the task associated with the time presentation 1440. In some embodiments, a checkpoint may require the user to remaining in a proximity of the checkpoint for a predetermined period of time presented to the user through the timer presentation 1440. During this period, the mobile device 150 may periodically (e.g., every 5 seconds, 10 seconds, or 60 seconds) transmit the geo-location data of the mobile device 150 to the backend device 110 for determining whether the mobile device 150 is still within the proximity of the checkpoint. When the backend device 110 (or the mobile device 150) determines the user has moved outside of the proximity of the checkpoint before the time expires, the time displayed by the timer presentation 1440 may freeze, and the mobile device 150 may be configured to display a message to the user indicating that the user has completed the task of remaining with the proximity of the checkpoint.

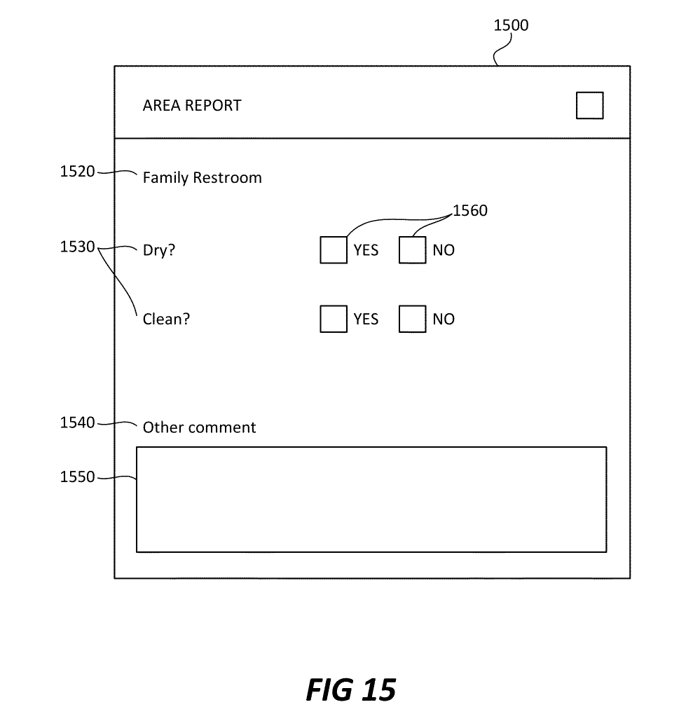

Now referring to FIGS. 1-15, illustrated is an example of a checklist interface 1500 presented to the user as a task associated with a checkpoint. The checklist interface 1500 may include a selectable instruction element 1510 which, if selected by the user, may display a set of instructions associated with completing the checklist, where the set of instructions may provide sufficient guidance for the user to complete the checklist presented by the checklist interface 1500. The checklist interface 1500 may include a description element 1520 that describes a location or at least one item, the condition of which may be examined. In some embodiments, at least one condition 1530 may be presented to the user, and the user may select, by interacting with at least one selectable condition element 1560, each of which may indicate the condition of the location or the item. In addition to preset selectable condition element 1560, the checklist interface 1500 may prompt for further input from the user by displaying a prompt 1540 and a text field 1550 (a voice input element and/or a camera activation element) for the user to input further comments related to the task.

In further embodiments, the mobile device 150 may allow the user to manually select one or more additional modes such as, but not limited to, a facility display mode that may display a representation (e.g., a map) of the facility, a checkpoint route display mode that may display a representation (e.g., a map) of the checkpoints and their associated tags, or the like.

Assist System

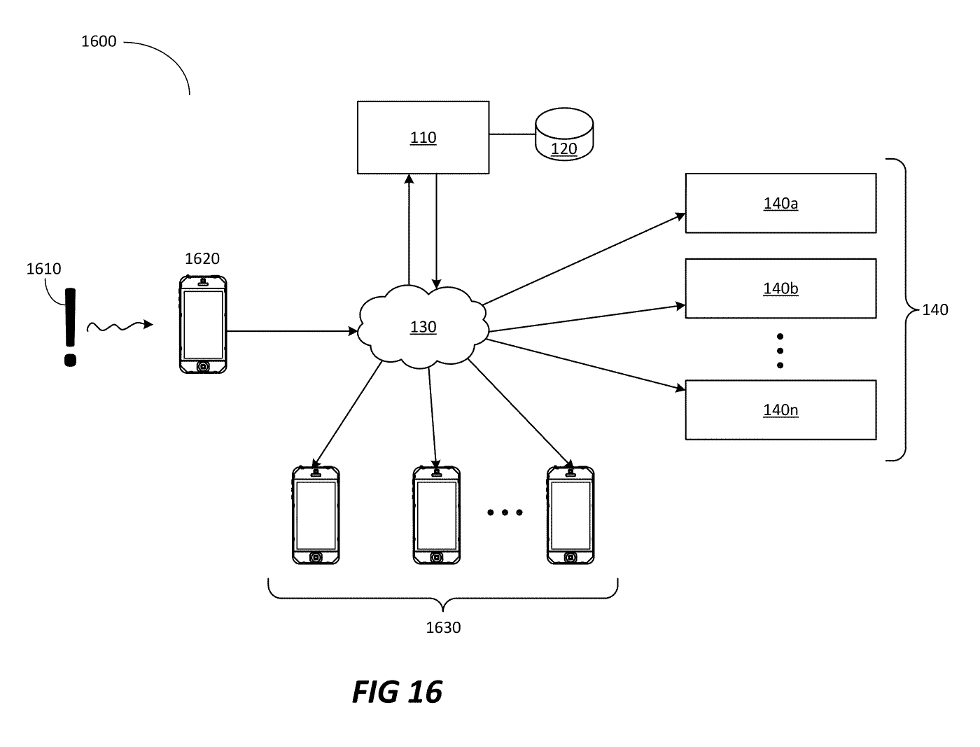

FIG. 16 illustrates embodiments of an assist system 1600 for reporting and responding to incidents occurred within or around the facility according to various embodiments. Referring to FIGS. 1-16, the assist system 1600 may be deployed in a situation where the user associated with a reporting mobile device 1620 may require assistance or desire to notify personnel associated with other mobile devices 1630, the backend device 110, and/or the client device 140. The client device 140 may include a plurality of client devices 140a-140n. The reporting mobile device 1620 may be one of the mobile devices 150 illustrated in FIGS. 1-15. In some embodiments, the user associated with the reporting mobile device 1620 may perceive an incident 1610 (or an event that has already occurred or yet to occur) that may require the activation of the assist system 1600.

In some embodiments, the reporting mobile device 1620 (e.g., through the user input device 340) may be configured to send a notice to the backend device 110 through the network 130. The backend device 110 may receive the notice and analyze information contained therein. In some embodiments, the backend device 110 may identify the type of incident that the incident 1610 may be (e.g., from the notice sent by the reporting mobile device 1620), and send messages and/or instructions to the reporting mobile device 1620, the other mobile devices 1630, and the client device 140 based on the type of incident and predetermined rules for responding to that type of incident. In some embodiments, the backend device 110 may send the reporting mobile device 1620, via the network 130, instructions specifying response procedures regarding the incident and/or request for further information. In further embodiments, the backend device 110 may send similar or different instructions and/or the request to other mobile devices 1630 and the client device 140. In various embodiments, the instructions and request for further information may be sent to each device based on the role of the user associated with each device. In alternative embodiments, the reporting mobile device 1620 may be configured to transmit incident notices over the network 130 directly to the other mobile devices 1630 and/or the client device 140, without first transmitting it to the backend device 110. Next, the notice may then be transmitted to the backend device 110 by at least one of the reporting mobile device 1620, the other mobile devices 1630, and the client device 140.

Still referring to FIGS. 1-16, in some embodiments, the reporting mobile device 1620 may be configured to provide the associated user with a manual operator (such as, but not limited to, a touchscreen operator, button, switch, or the like) that can be selectively, manually operated to cause the reporting mobile device 1620 to transmit the incident notice (or other pre-defined messages) in the manner described. In a non-limiting example, the incident response element 705 (shown as an icon containing text “EMERGENCY”) in FIG. 7 may be such manual operator. The incident 1610 may be false alarm, assault, attempted burglary, ban notice, customer service, non-criminal other, vandalism, arrest by security, theft, slip and fall, lost property, water leak, property damage, fire, tenant lease violation, personal accident, burglary from motor vehicle, improper conduct, vehicle accident, active shooter, and/or the like.

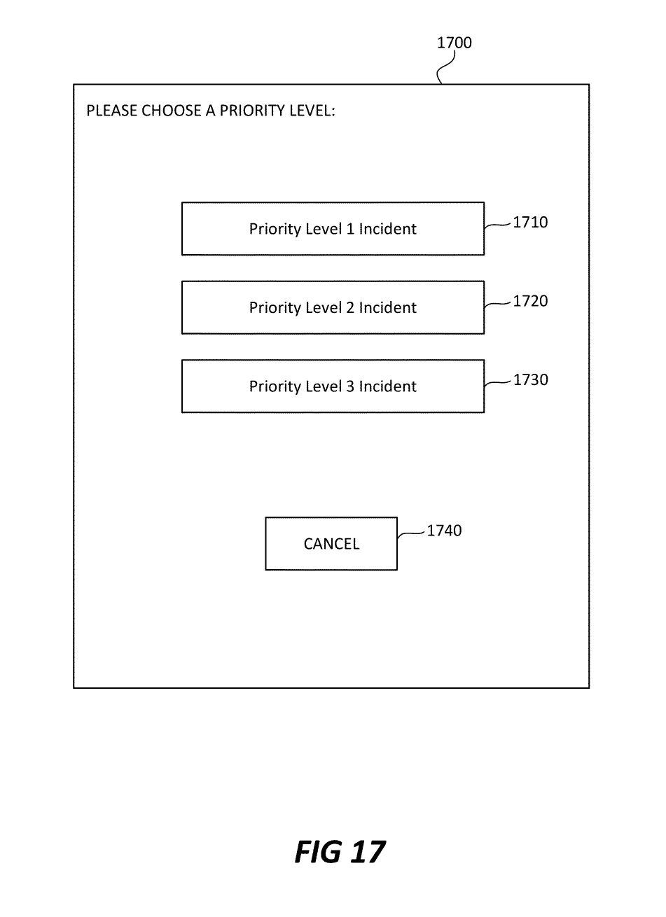

Now referring to FIGS. 1-17, the reporting mobile device 1620 may be configured to provide, via the display device 330, one or more priority levels classifying incidents that may occur within the facility to the user, in response to the user triggering the incident response element 705. FIG. 17 illustrates a priority level selection interface 1700 according to various embodiments, in which the possible incidents may be classified and grouped based on priority level and presented to the user for selection. Priority levels, as illustrated by three separate priority levels 1710-1730 in the priority level selection interface 1700, may represent the seriousness of the incident. In some embodiments, rules specifying what messages, instructions, or requests for further instructions may be set based on the priority level of the incident and/or each individual type of incident.

The classifying of the possible incidents may be based on classifying each type of possible incidence into priority levels. In one non-limiting example, active shooter, assault with deadly weapon, fire, robbery/burglary, serious bodily injury to a person, and the like are grouped as a top priority level (e.g., a priority level 1 incident 1710), while slip/fall involving minor injuries, lost property, vandalism, arrest by security, theft, and the like may be grouped as another separate priority level that may be lower than the top priority level (e.g., a priority level 2 incident 1720). In further embodiments, tenant lease violation, customer dispute, mall traffic congestion, water leak, and the like may be grouped as lowest priority level (e.g., a priority level 3 incident 1730). It should be appreciated by one having ordinary skill in the art that, the types of incidents above may be classified differently by designated personnel or algorithm, and there may be more or less numbers of priority levels with various levels of seriousness. The type of events may be reclassified by a designated personnel or algorithm.

In further embodiments, the priority levels may be based on general factors of seriousness or urgency of the incident. For example, all incidents involving (potential and actual) death or serious bodily injuries may be classified as a top priority level (e.g., a priority level 1 incident 1710), all incidents involving (potential and minor) injuries may be classified as another separate priority level that may be lower than the top priority level (e.g., a priority level 2 incident 1720), and non-urgent events may be classified as the lowest priority level (e.g., a priority level 3 incident 1730).

The reporting mobile device 1620 may allow the user to select, via the user input device 340, the priority levels 1710-1730 of the incident for the purpose of reporting the incident. The user may select one of the priority levels that correspond to the incident 1610 that the user perceives. The priority level selection interface 1700 may allow the user to cancel transmission of the incident notice by providing an user selectable icon 1740 that, if selected, would cancel the message sending and exit the priority level selection interface 1700. The reporting mobile device 1620 may include interactive elements for the user to assess information related to each of the priority levels such that the user may make an informed decision.

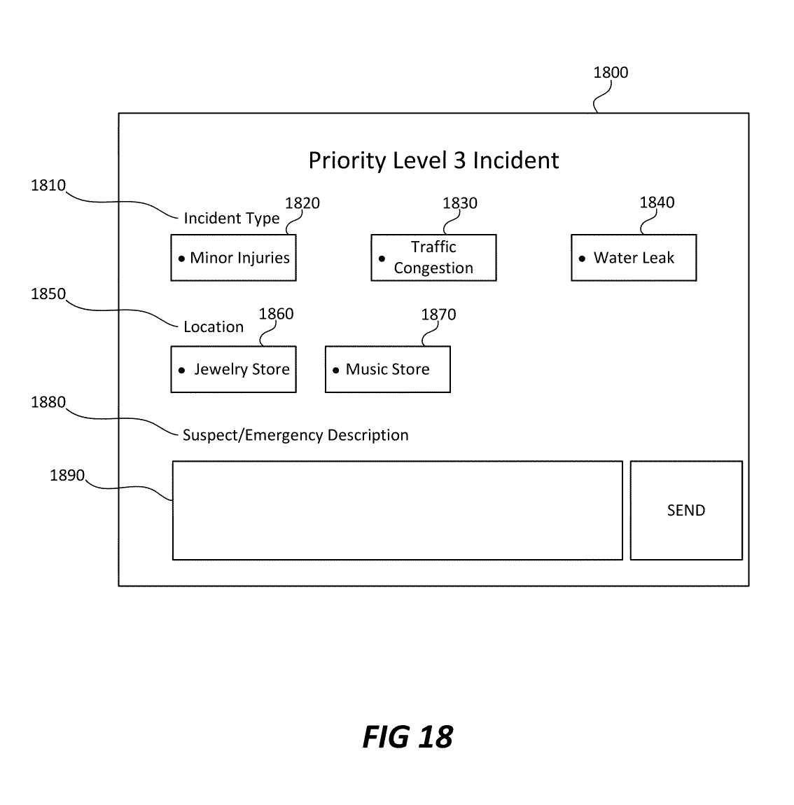

Referring to FIGS. 1-18, the reporting mobile device 1620 may be configured to prompt the user for information about the incident 1610 by providing user with an incident report interface 1800, as illustrated in FIG. 18. The incident report interface 1800 may be presented to the user before or after the user selects a priority level, or the user may be prompted for information via the incident report interface 1800 without ever having a priority level selection interface 1700 being presented. In some embodiments, the reporting mobile device 1620 may present the user with an incident type prompt 1810 (e.g., illustrated by the text “incident type” in FIG. 18) to prompt the user to select a type of incident. The user may be presented with at least one possible incident element 1820-1840 for selection. In the nonlimiting example illustrated in FIG. 18, the incidents presented to the user may include minor injuries 1820, traffic congestion 1830, and water leak 1840. Alternatively, the reporting mobile device may enable text field, voice messaging, live call, pictures, and/or videos for the user to identify the specific events.

In some embodiments, all possible incidents may be listed as incident elements 1820-1840 for the user to select. In other embodiments, the incident elements 1820-1840 may list selected incidents based on the location of the reporting mobile device 1620 (e.g., list only incidents that may occur within a proximity of the location of the reporting mobile device 1620), the priority level selected (e.g., list only incidents associated with the priority level selected), the time at which the incident is reported (e.g., list only incidents associated with a certain time period), a combination thereof, or the like.

The reporting mobile device 1620 may present the user with an incident location prompt 1850 (e.g., illustrated by the text “location” in FIG. 1) to prompt the user to select a location in or around which the incident has occurred. In some embodiments, the user may be presented with at least one possible location element 1860-1870 for selection. In the nonlimiting example illustrated in FIG. 18, the incident locations may be a jewelry store 1860 and a music store 1870. Alternatively, the reporting mobile device may enable text field, voice messaging, live call, pictures, and/or videos for the user to identify the location.

In some embodiments, all possible incident locations may be listed as the location elements 1860-1870. In other embodiments, the locations elements 1860-1870 presented to the user may be based on the location of the reporting mobile device 1620 (e.g., list only a location to the user if the location is within a predetermined distance from the location of the reporting mobile device 1620), the priority level selected (e.g., list only locations associated with the priority level selected), the time at which the incident is reported (e.g., list only locations associated with a certain time period), a combination thereof, or the like.

In some embodiments, the user may, via an incident description element 1890 (such as, but not limited to, a text input, a voice input, a photographic input, and a video input), additional information prompted by the information prompt 1880. The information prompted may include, but not limited to, suspect description, further incident description, additional information not requested, and/or the like.

In some embodiments, when the user of the reporting mobile device 1620 selects a high priority level event, the reporting mobile device 1620 may be configured to transmit a notification without first prompting the user for more details of the incident, for example, by presenting the incident report interface 1800. This may allow the assist system 1600 to receive immediate notification of urgent incidents by simplifying the process and reducing the time it takes for the user to transmit the incident notice. Given that the incident notice may be transmitted with a location data and a time stamp, it may be sufficient to transmit the incident notice without additional information requested by the incident report interface 1800.

In particular embodiments, the reporting mobile device 1620 may be configured such that, in response to a triggering event, the reporting mobile device 1620 may initiate a timing process to time a predefined time period (such as, but not limited to, two seconds, five seconds, or ten seconds) from the time of the triggering event. The mobile device 150 may be configured to transmits (or abort the transmission of) the incident notice after (or in response to) the expiration of that predefined time period. In further embodiments, the mobile device 150 may be configured to allow the user to send or cancelling of the incident notice within the predefined time period, i.e., before the expiration of the time period. The triggering event may be the incident response element 705 being selectively activated by the user associated with the reporting mobile device 1620, a priority level being selected in the priority level selection interface 1700, the completion of inputting additional information regarding the incident in the incident report interface 1800, a combination therefore, or the like.

Referring to FIGS. 1-19, FIG. 19 illustrates a reporting timer interface 1900 for reporting any predefined task according to various embodiments. The reporting timer interface 1900 may provide alphanumeric and/or graphical display 1910 to the user, through the display device 330 of the reporting mobile device 1620, representation of time elapsed since the occurrence of the triggering event, total length of the predefined time period, and/or time remaining in the predefined time period. In some embodiments, the display 1910 may include a time progress bar 1920 graphically depicting the time lapsed (e.g., the shaded portion), the time remaining (e.g., the unshaded portion), and/or the total length of the predefined period (e.g., the entire length of the bar). The time progress bar 1920 may updated dynamically according to the actual time elapsed or remaining

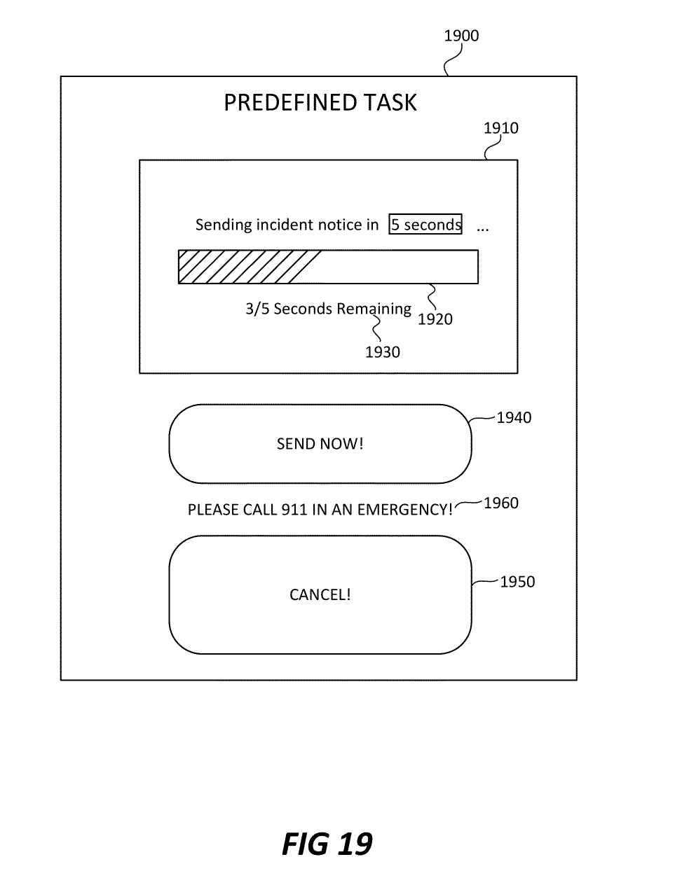

In some embodiments, the reporting timer interface 1900 may include a transmit element 1940 (denoted as “SEND NOW!” in FIG. 19) where the incident notice may be transmitted from the reporting mobile device 1620 immediately, before the expiration of the predefined time period. The user may select the transmit element 1940 when it is obvious, before the expiration of the predefined time period, that an incidence has occurred. In further embodiments, the reporting timer interface 1900 may provide an abort element 1950 (denoted as “CANCEL!” in FIG. 19) where the transmission of the incident notice may be cancelled before the expiration of the predefined time period. The user may select the abort element 1950 before the predefined time period if the user discovers that a mistake was made as to the occurrence of an incidence. The predefined time period may be determined by personnel associated with the backend device 110 and/or other suitable designated personnel, based on environment factors, such as the nature of the work, the type of facility, the time of day/week, and/or the like.

In addition, the reporting timer interface 1900 may include at least one warning statement 1960 that may remind or prompt the user of the reporting mobile device 1620 to contact emergency responders (e.g., police officers, ambulance, fire department, and/or the like). In various embodiments, the warning statement 1960 may be configured as an user interactive element. When selected, the warning statement 1960 may be configured to automatically dial a number of emergency responders. In alternative embodiments, a regular dialer may be displayed with the telephone number for the emergency responders already inputted. The user may simply press a dial key to connect to the emergency responders.

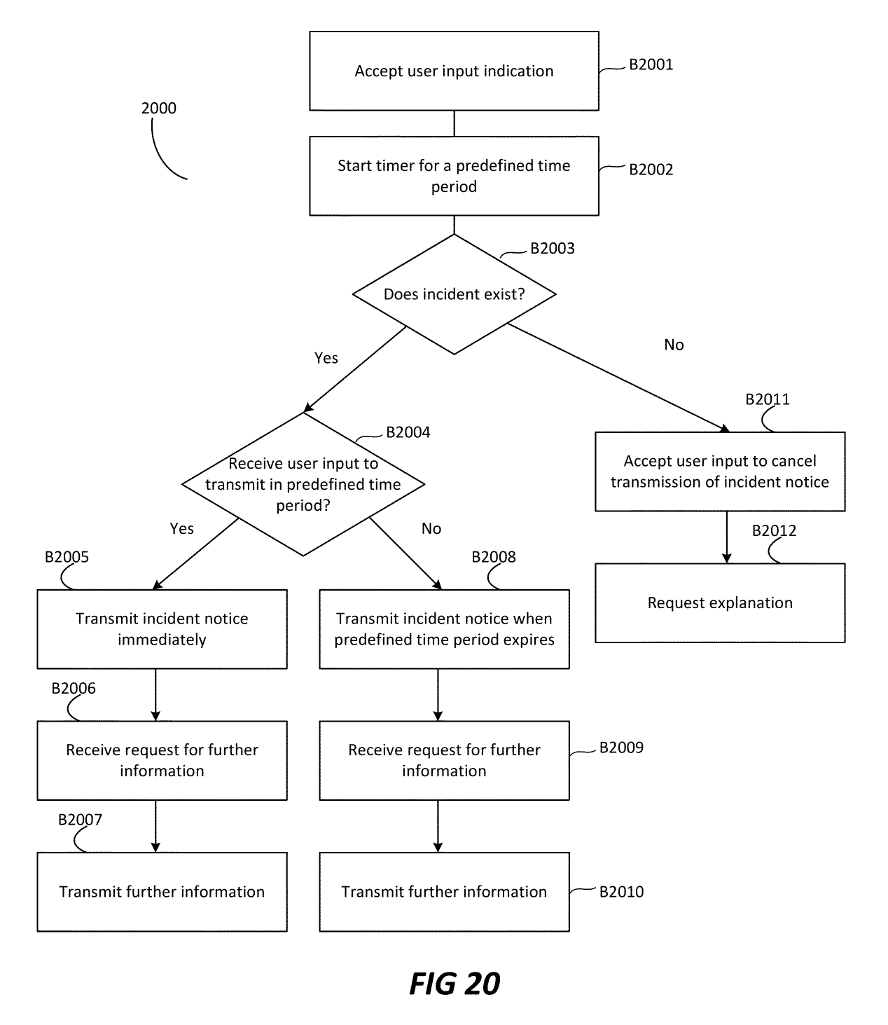

Referring to FIGS. 1-20, FIG. 20 is a process flow chart illustrating an incident report timer process 2000 according to various embodiments. At block B2001, the reporting mobile device 1620 may receive a user input indicating that an incident may exist, and the rest of the incident report timer process 2000 may be triggered in response to the user input (the user input may be a triggering event). The triggering event may be the incident response element 705 being selectively activated by the user associated with the reporting mobile device 1620, a priority level being selected in the priority level selection interface 1700, the completion of inputting additional information regarding the incident in the incident report interface 1800, a combination therefore, or the like.

At block B2002, a timer is started by the reporting mobile device 1620 via the timer device 380 of the reporting mobile device 1620. The predefined time period may be determined by personnel associated with the backend device 110 and/or other suitable designated personnel in the manner described. The timer may be displayed via the reporting timer interface 1900 as described to notify the user time elapse, time remaining, and the entire predefined time period. Next at block B2003, the reporting mobile device 1620 may be configured to determine if the incident exists. In some embodiments, the user may perceive the incident closely and determined whether the incident is in fact occurring, and convey the finding to the reporting mobile device 1620 through the user input device 340 of the reporting mobile device 1620.

If the incident does not exist (e.g., when the user realizes that a mistake has been made), then at block B2011, the reporting mobile device 1620 may accept user input to cancel transmission of the incident notice within the predefined time period. The user may cancel transmission by selecting, for example, the abort element 1950 (denoted as “CANCEL!” in FIG. 19) of the reporting timer interface 1900 before the expiration of the predefined time period. Next at block B2012, in response to the user canceling the transmission, the reporting mobile device 1620 may be configured to request and accept user input for comments from the user related to the incident. The reporting mobile device 1620 may be configured to transmit such input to the backend device 110 and/or other devices.

If the incident in fact exists, the reporting mobile device 1620 may be configured to receive user input and determine whether a user input is received during the predefined time period, at block B2004. If the user selects to transmit the incident notice within the predefined time period, the reporting mobile device 1620 may be configured to transmit the incident notice immediately upon receiving such user selection, before the expiration of the predefined time period, at block B2005. Next at block B2006, the reporting mobile device 1620 may request further information from the user, e.g., by displaying a prompt with the display device 330 and allow the user to input further information related to the event via the user input device 340. Next at block B2007, the reporting mobile device 1620 may send the further information obtained to the backend device 110 and/or other devices.

If the user does not select to transmit the incident notice within the predefined time period, e.g., no user input has been received by the reporting mobile device 1620 within the predefined time period, then the reporting mobile device 1620 may be configured to transmit the incident notice to the backend device 110 and/or other devices in response to the expiration of the predefined time period, at block B2008. Next at block B2009, the reporting mobile device 1620 may request further information from the user, e.g., by displaying a prompt with the display device 330 and allow the user to input further information related to the event via the user input device 340. Next at block B2010, the reporting mobile device 1620 may send the further information obtained to the backend device 110 and/or other devices.

In further embodiments, the mobile device 120 is configured to display visual indicia, display an audio message and/or provide other user-perceptible information, or combinations thereof, via the user notification device 370 of the reporting mobile device 1620, during the predefined time period.

In particular embodiments, the incident notice may include (or may be sent with) additional data including, but not limited to, geo-location data corresponding to the location of the reporting mobile device 1620 at the time that the triggering event occurs (e.g., as determined by a GPS or other location determining device associated with the reporting mobile device 1620), time information corresponding to the time that the triggering event occurs (e.g., as determined by timer electronics associated with the reporting mobile device 1620), sensor information recorded by the reporting mobile device 1620 before or at the time that the triggering event occurs, user-input information recorded by the reporting mobile device 1620 before or at the time that the triggering event occurs, or other suitable information.

Now referring to FIG. 1-21, illustrated is a block diagram representing the content of an incident notice 2100 according to various embodiments. The incident notice 2100 sent from the reporting mobile device 1620 to the backend device 110 may include an incident description 2110, the identity of the user 2120, the contact information 2130 for the reporting mobile device 1620, and the geo-location 2140 of the reporting mobile device 2140.

The incident description 2110 may be text, audio, or video data obtained by the reporting mobile device 1620 regarding the incident, such data may be inputted by the user associated with the reporting mobile device 1620 or captured (or otherwise sensed) by the reporting mobile device 1620. The identity of the user 2120 may be various data identifying the user, including, but not limited to, a name of the user, an identification number of the user, a company code associated with the user, a role associated with the user. Such identification may be obtained by the reporting mobile device 1620 or the backend device 110 during the login. In some embodiments, the contact information 2130 for the reporting mobile device 1620 may include a phone number or other suitable communication information associated with the reporting mobile device 1620. In further embodiments, the geo-location 2140 of the reporting mobile device 2140 may be obtained from the geo-location device 360 of the reporting mobile device 1620.

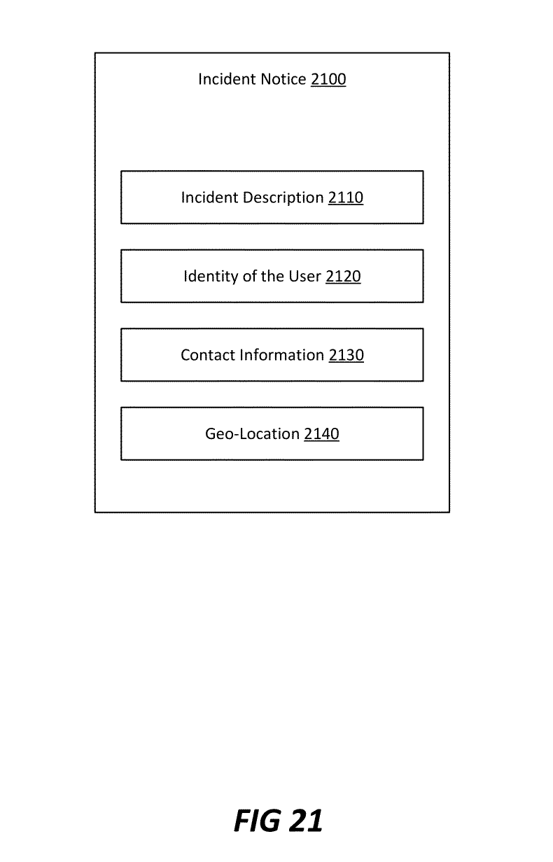

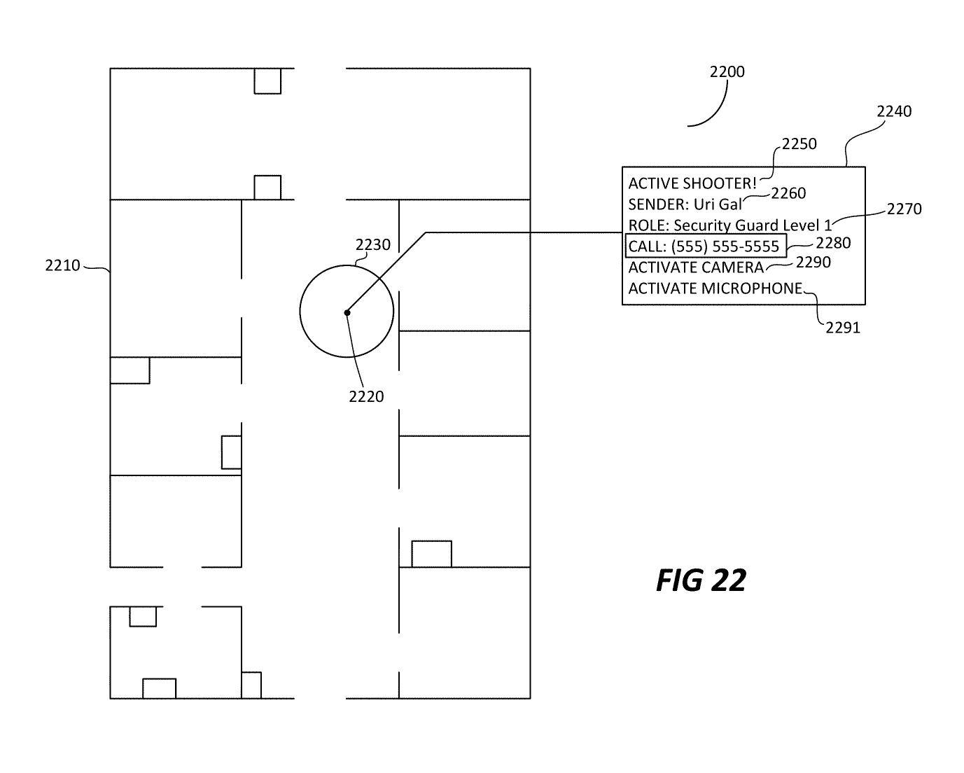

FIG. 22 illustrates an incident display interface 2200 configured to be displayed by the backend device 110 according to various embodiments. Referring to FIGS. 1-22, the backend device 110 may receive the incident notice (e.g., one illustrated by FIG. 21) transmitted by the reporting mobile device 1620. The backend device 110 may be configured to display the location 2220 of the reporting mobile device 1620 as determined based on the geo-location 2140 in the incident notice 2100 received from the reporting mobile device 1620. The location 2220 of the reporting mobile device 1620 may be displayed on a map 2210 (or plan view) of the facility, such as a shopping mall, in which the assist system 1600 may be employed. In other embodiments, the incident display interface 2200 may alternatively, represent one or more other types of facilities having a plurality of different definable areas, including, but not limited to one or more school campuses, corporate campuses, office buildings, warehouses, residential areas, business areas, cities, towns, counties, countries, portions thereof, combinations thereof, or the like. In some embodiments, the location 2220 of the reporting mobile device 1620 may be emphasized by an accent 2230, such as, but not limited to, highlight, circle, and/or the like, to make noticeable the location 2220 of the reporting mobile device 1620 in the incident display interface 2200. A profile pictures or avatar of the user associated with the reporting mobile device 1620 may be displayed.

In further embodiments, the backend device 110 may display additional information received from reporting mobile device 1620 in an incident information window 2240, the information displayed including, but not limited to, an incident type 2250, an identification 2260 of the user of reporting mobile device 1620, a role 2270 associated with reporting mobile device 1620, and a contact element 2280 associated with reporting mobile device 1620, all of which may derive. The of the incident type 2250 may be extracted from the received incident description 2110, the identification 2260 of the user and the role 2270 associated with the reporting mobile device 1620 may be extracted from the received identity of the user 2120, and the contact element 2280 associated with reporting mobile device 1620 may be extracted from the contact information 2130. In some embodiments, the contact element 2280 may include a phone number (or other suitable contact information) as shown in FIG. 22, and may be an interactive element that may support a “click-to-call” function, such that the personnel associated with the backend device 110 may select the contact element 2280 by clicking, touching, and/or the like, to contact the user of the reporting mobile device 1620 through voice call, video call, text message, and/or other suitable means of communication.

In some embodiments, the backend device 110 may be configured send a “take-over” command, e.g., via the activate camera element 2290 or the activate microphone element 2291, to the reporting mobile device 1620 to force reporting mobile device 1620 to obtain data from its microphone, photographic camera, video camera, and/or other sensors, and send the data obtained to the backend device 110 without authorization or action by the user. In some embodiments, the backend device 110 may periodically receive data (e.g., through periodic updates every 0.5 second, 1 second, or 2 seconds) or receive data in real-time from reporting mobile device 1620 once an incident has been reported, and the backend device 110 may be configured to display the updated information of the incident. In one non-limiting example, the backend device 110 may be configured to display a moving location of the reporting mobile device 1620 as the reporting mobile device 1620 moves in real-time, and information may be transferred to the backend device 110 and updated in real time.

In some embodiments in which a plurality of reporting mobile devices 1620 may be sending information related to the event as each of their associated user is perceiving the event, the backend device 110 may be configured to display a plurality of indicia, each representing a separate reporting mobile device 1620. Information related to each of the reporting mobile device 1620 may also be displayed in similar manner described. In further embodiments, the backend device may estimate an location of the event based on the location of the plurality of the reporting mobile device 1620 that send information related to the same event. In some instances, the event location is a weight average location of the location of the plurality of the reporting mobile devices 1620.

In further embodiments, the incident display interface 2200 may be displayed in response to the backend device 110 receiving an incident notice (e.g., the incident notice 2100) or when the backend device 110 receiving a notice indicating that at least one reporting mobile devices 1620 has initiated communication (e.g., contacts, calls, texts, and/or the like) with an emergency responder.

In addition, the incident display interface 2200 may display not only a map with the facility view, but also a general-purpose map including the facility (or a plurality of facilities under management) as well as streets, buildings, and/or infrastructure not under management. For example, the incident display interface 2200 may include a general-purpose map application (e.g., an interaction with a mobile map service provider application, a dedicated map feature in the assist system 1600, and/or the like). The user of the backend device 110 may zoom in from the general-purpose map (or select an user interactive element) to assess a facility view of the facility in which the user of the reporting mobile device 1620 has reported an event or contacted an emergency responder. The incident information window 2240 and the location 2220 may be displayed on the general-purpose map in a similar manner as described with respect to a facility-view of the map.

In some embodiments, users of the backend device 110, the reporting mobile device 1620, the other mobile devices 1630, the client devices 140, and/or the like may be able to view different amount of information based on the role associated with the device/user. For example, the maps (e.g., the facility-view map as well as the general-purpose map) and the corresponding information displayed thereon (e.g., the position 2220, the incident information window 2240, and/or the like) may be viewable by the user of the backend device 110 only. In other words, no users other than users associated with the backend device 110 may be able to view the maps and the information displayed thereon. In another example, the map and the information displayed thereon may be viewed by the user associated with the backend device 110, while only the incident information window 2240 may be viewable by other users.

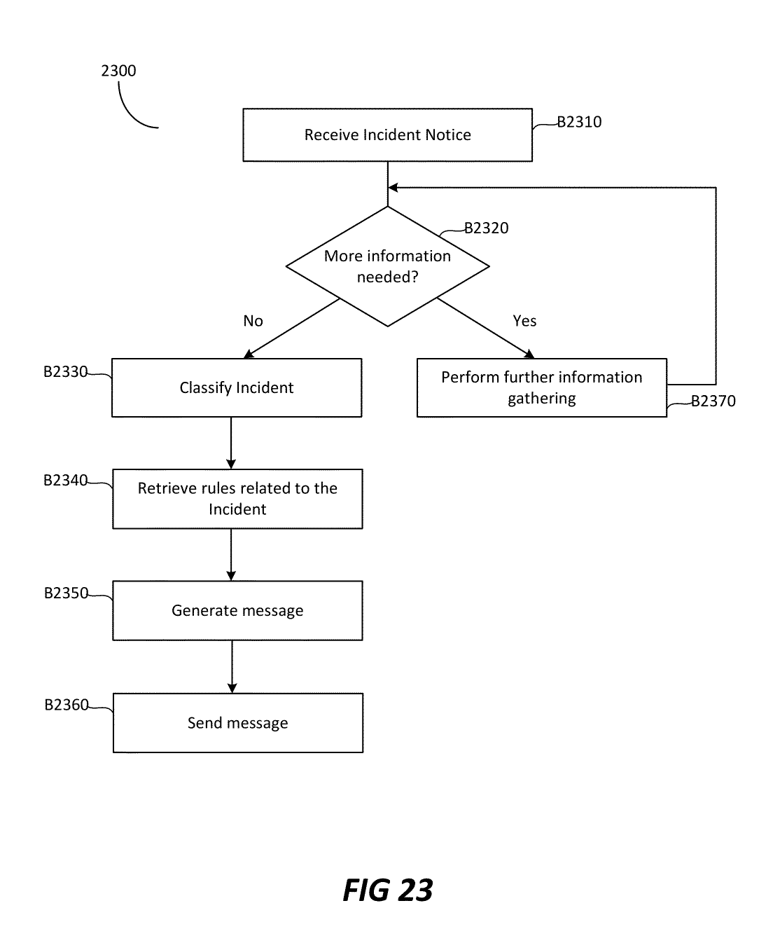

FIG. 23 is a process flowchart illustrating a method performed by the backend device 110 for responding to an incident according to various embodiments. Referring to FIGS. 1-23, at block B2310, the backend device 110 receive information related to the incident through the reporting mobile device 1620 in the manner described, the incident notice may be illustrated in FIG. 21. Next at block B2320, the backend device 110 may determine whether more information is required before dissemination information to other devices. In some embodiments, the backend device 110 may this determination based on a set of algorithms stored in the memory of the backend device 110 and executed by the processor of the backend device 110, the algorithms may specify, for example, that incidents associate with one or more particular priority levels may require more information, whereas incidents associated with other priority levels may not require more information. In further embodiments, the algorithm may specify that some types of incident may require more information whereas other types of incident may not require more information. The more information may require information related to a suspect description, a specific location associated with the incident, a situation description, and/or additional comments by the user. The backend device 110 may determine automatically whether more information is needed, or at the director of the personnel associated with the backend device 110.

Next at step B2370, if it is determined that further information may be required, the backend device 110 may proceed with further information gathering including, but not limited to, sending the reporting mobile device 1620 a request for more information, sending other mobile devices 150 requests to investigate to obtain more information, taking over the camera, microphone, and/or sensors of the reporting mobile device 1620, and/or the like. After further information gathering, the backend device 110 may receive more information related to the incident, and the backend device 110 may again determine whether more information is needed at block B2320.

If the backend device 110 determines that information is not required, at block B2330, the backend device 110 may classify the incident by, for example, matching the incident described by the incident notice with a database of potential incidents, where each potential incident may be associated with a classification or category. Next at block B2340, the backend device 110 may retrieve rules or algorithms related to responding to the particular incident or the class of incidents as described by the incident notice. Such rules may include, but not limited to, information related to the particular incident or class of incidents and instructions for responding to the incident. In one example, instructions related to an active shooter for the client devices 140 may include, but not limited to, evacuate customers through the emergency exists, lock down the store, contact the police, find cover, and/or the like.

Next at block B2350, the backend device 110 may generate messages to each separate device (e.g., the reporting mobile device 1620, the other mobile devices 1630, and/or the client device 140) based on roles associated with each of the users of the devices as described.

Next at block B2360, the backend device 110 may send the generated messages to each device, via the network 130. In some embodiments, the backend device 110 may be configured to send, automatically or manually by the personnel, messages to devices of a subgroup of the devices (based on roles of the users associated with these devices), e.g., all other mobile devices 1630 associated with security guards, or all devices within a geographical boundary.

In some embodiments, more than one user may perceived the same incident and send incident notices to the backend device 110 simultaneously or almost simultaneously. Thus, in some embodiments, when a plurality of reporting mobile devices 1620 are sending a plurality of incident notices to the backend device 110, the backend device 110 may aggregate the incident notices related to a same incident. In particular embodiments, the backend device 110 may aggregate the separate geo-location data of the plurality of the reporting mobile devices 1620 and display the location of all of the reporting mobile devices 1620 on the same display device 230 of the backend device 110. Furthermore, the plurality of separate geo-location data may be used to calculate an estimate location of the incident even, e.g., by taking a midpoint of all geo-locations of the separate geo-location data of separate reporting mobile devices 1620.

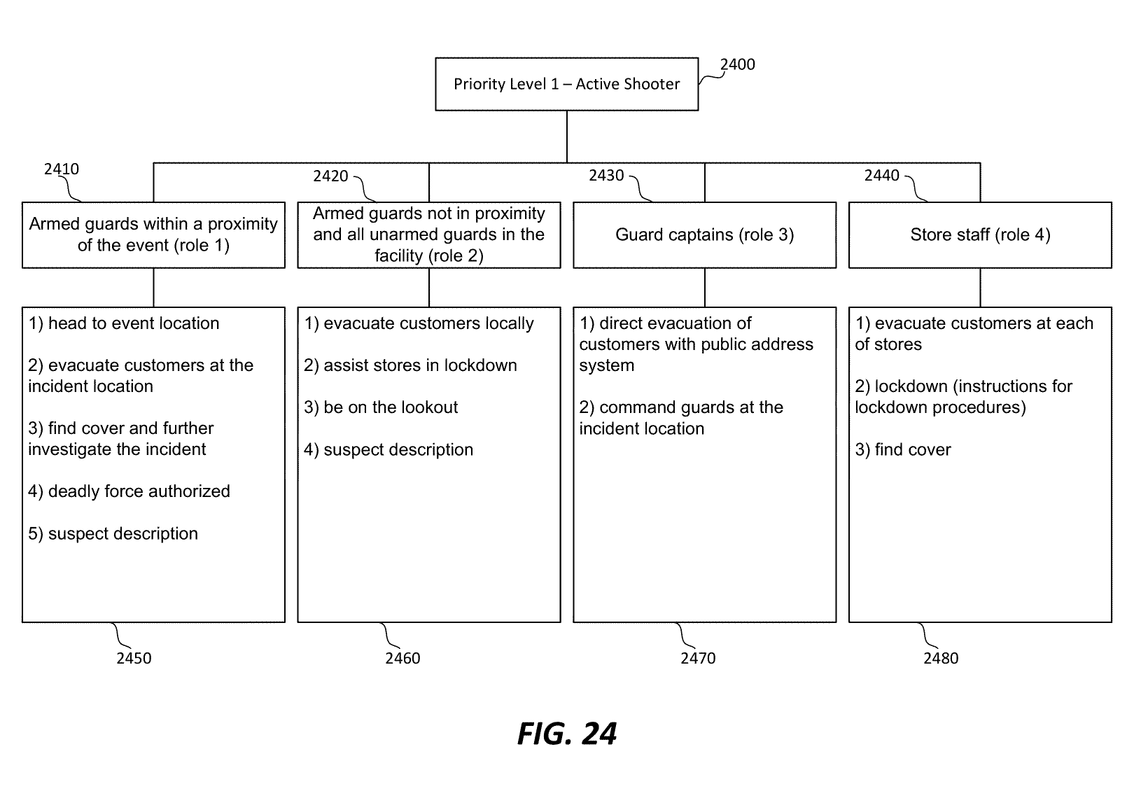

In some embodiments, separate instructions and messages may be sent to each of the reporting mobile device 1620, the other mobile devices 1630, and/or the client device 140 based on the roles associated. FIG. 24 illustrates a non-limiting example of separate and customized instructions based on roles. A set of rules for notices and instructions may be stored in the memory 220 of the backend device 110 and/or the database 120 in the manner described. The each set of rules may correspond to the priority level and/or the specific type incident. FIG. 24 illustrates a set of rules for generating messages for an active shooter scenario 2400, which is a type of priority 1 event. Messages based on four or more roles may be generated, the roles may include, but not limited to, armed guards within a proximity of the event (role 1) 2410, armed guards not in proximity and all unarmed guards in the facility (role 2) 2420, guard captains (role 3) 2430, and store staff (role 4) 2440. Roles 1-3 may be associated with the users of other mobile devices 1630, role 4 may be associated with a user of the client device 140. In some embodiments, proximity may be defined as a predetermined area around the event location and/or the location of the reporting mobile device 1620.

The rules 2450-2480 may specify what notices and/or instructions may be sent to the devices based on associated roles. For instance, the first set of rules 2450 may specify that the instructions sent to devices associated with role 1 2410 may include informing the user to 1) head to event location, 2) evacuate customers at the incident location, 3) find cover and further investigate the incident, 4) deadly force authorized, and 5) suspect description. The second set of rules 2460 for role 2 2420 may include informing the user to 1) evacuate customers locally, 2) assist stores in lockdown, 3) be on the lookout, and 4) suspect description. The third set of rules 2470 for role 3 2430 may include informing the user to 1) direct evacuation of customers with public address system, and 2) command guards at the incident location. The fourth set of rules 2480 for role 4 2440 may include informing the user to 1) evacuate customers at each of stores, 2) lockdown (instructions for lockdown procedures), and 3) find cover.

It should be appreciate by one of ordinary skill in the art that, similar system involving more or less number of roles and/or for other types of incidents may be implemented in the same or similar manner. In some embodiments, the notices and instructions stored may be templates that require further customization. For example, the rules may include adding suspect description, and the backend device 110 may extract suspect description from the incident notice sent by the reporting mobile device 1620, and combine the suspect description with other instructions specified by the rules into a single message to be sent to particular devices. In some embodiments, the messages may be customized and sent automatically by the backend device 110 to the client device 140 and/or the other mobile devices 1630. In other embodiments, the messages may be customized and sent by the personnel associated with the backend device 110 manually.

In some embodiments, the roles upon which the instructions are based on may be determined before the incident has taken place. For example, these roles may be based on the job description of the user, whether the user is armed or not, whether the user is a store staff, a security staff, a cleaning staff, a maintenance staff, an engineering staff, or the like. In further embodiments, the roles may be determined after the incident has occurred, such that the roles may be related to one or more aspects of the incident. For example, the roles may be determined based on the proximity of the user to the incident. The backend device 110 may be configured to customize instructions and notices based on any of the role classification methods described above, or a combination of therein. In further embodiments, the roles may be static, or dynamically altered based on the category of the incident. As shown in FIG. 24, armed guards not in proximity and all unarmed guards are categorized in a same role, such that they may not be categorized in the same role in other types of incidents, such as, but not limited to, a shooting rampage in which all armed guards may be categorized in the same role, e.g., all armed guards may rush to the event location to neutralize the threat. This assures effective and detailed management of resources when an incident (such as an emergency) occurs, such that immediate and specific instructions may be disseminated to each individuals.

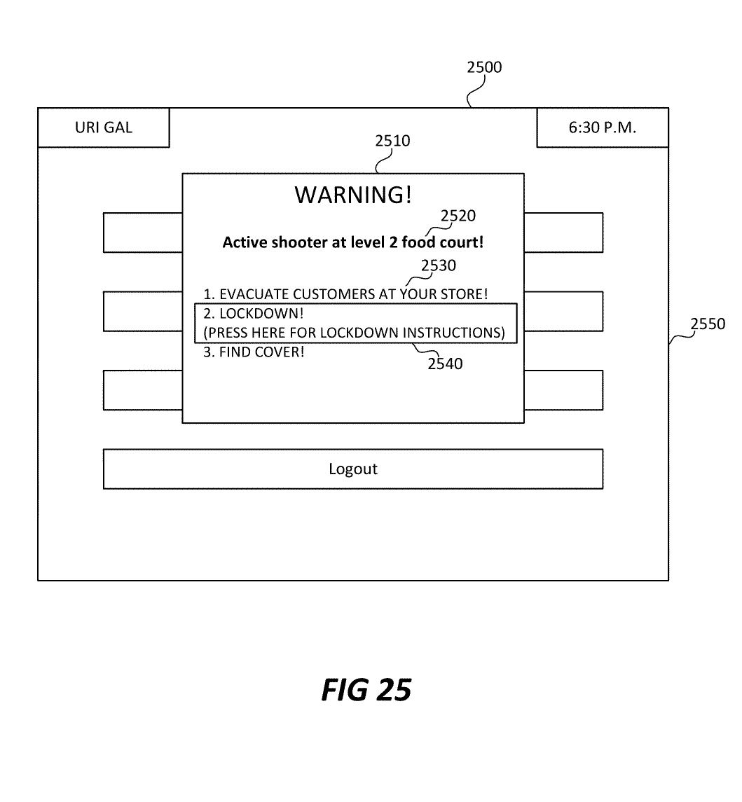

FIG. 25 illustrates an example of a client device interface 2500 that displays the message including a notification of the incident and the instructions in responding to the event. In some embodiments, when the client device 140 or the other mobile devices 1630 receive a message from the backend device 110, the message display 2510 may be laid over the application display 2550 which display other features of the staff management application and/or other applications on the client device 140 or the other mobile devices 1630. In some embodiments, a warning may couple the display of the message display 2510, where the warning may include, but not limited to, flashing, vibrating, and/or audio alarm. The message display 2510 may be a popup window that is presented to the user without any action or authorization by the user, in response of the client device 140 or the other mobile devices 1630 receiving the message.

In other embodiments, the user may receive a notification that a message has been received, and the user may select to retrieve the message for viewing, e.g., by accessing the message interface as described. In some embodiments, the message display 2510 may only be displayed automatically if the message is related to an incident of a predetermined level of priority. In other embodiments, the message display 2510 may be configured to be displayed for all messages received from the backend device 110. The message may include an incident notice 2520 that describes the incident, e.g., the text indicating that there is an active shooter at level 2 food court, as illustrated in FIG. 25. In addition, each messages may include a set of instructions 2530 that the user may follow, and the messages may include user-interactive elements that allow the user to access further information and instructions related to the event. As depicted by FIG. 25, the user may, through the user input device 440 of the client device 140, select to access lockdown instructions 2540. The client device 140 or the other mobile devices 1630 may store a set of instructions, or the client device 140 or the other mobile devices 1630 may download the set of instructions from the backend process 110.

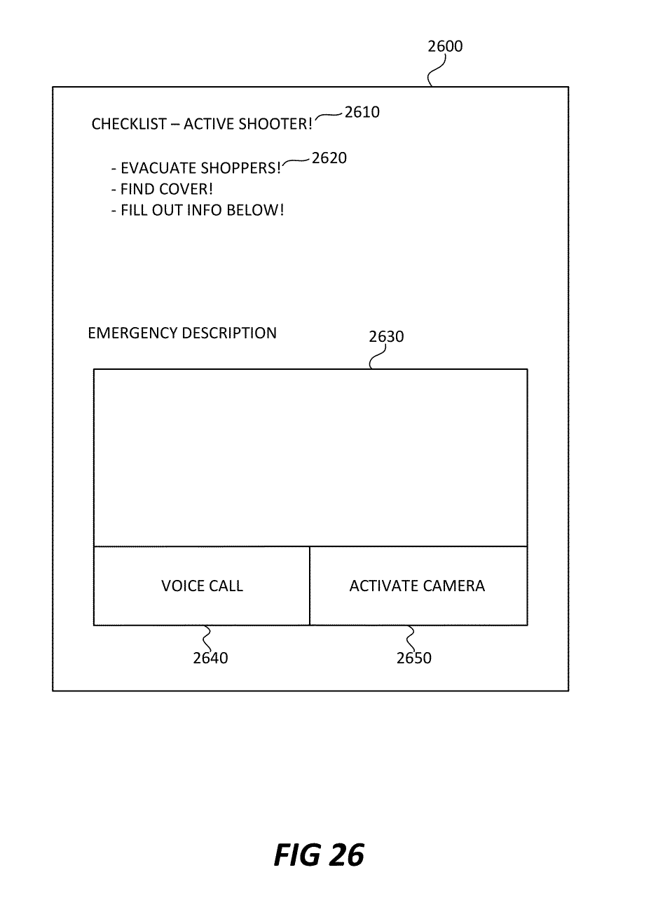

FIG. 26 represents an incidence report interface 2600 being displayed by the reporting mobile device 1620 according to various embodiments. Referring to FIG. 1-26, in some embodiments, backend device 110 may transmit a message to the reporting mobile device 1620 for further information in the manner described, or for providing the user associated with the reporting mobile device 1620 with a set of instructions. In some embodiments, the incident report interface 2600 may be presented in as a popup window with or without any authorization by the user, in the manner described with respect to the client device interface 2500. In further embodiments, the reporting mobile device 1620 may be configured to warn the user of receiving the message in the manner described. The message may include a list of instructions 2620 for the user of the reporting mobile device 1620 to follow, for example, in an active shooting situation, including, but not limited to evacuating shoppers, find cover, and fill out information below when safe. In further embodiments, the message sent to the reporting mobile device 1620 may include an incident description element 2630 such as a text field for the user to input more information related to the incident. The reporting mobile device 1620 may also include user interactive elements that allow the user to communicate with the personnel of the backend device 110, other mobile device users, and/or users of the client devices 140. Such user interactive elements may include, but not limited to, user a voice call element 2640 for initiating a voice call, and/or camera element 2650 for taking a photograph or video.

In some embodiments, if an incident exists, then the users may not be prompted by the reporting mobile device 1620 or the other mobile device 1630 for clock management operations such as, but not limited to, prompting the user to take/end a break, to start double/over time, and/or the like. This is to assure that the user is free of distraction during an on-going incident.

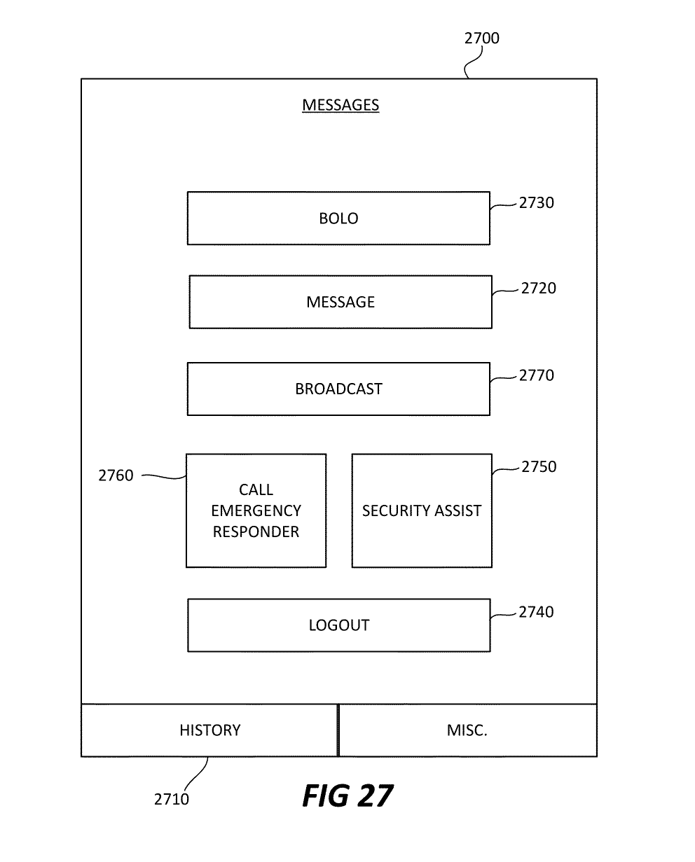

Now referring to FIGS. 1-27, FIG. 27 illustrates a message interface 2700 in the form of a display screen of the mobile device 150, the reporting mobile device 1620, the client device 140, or the other mobile devices 1630 according to various embodiments. The message interface 2700 may include an history element 2710, a message element 2720, a BOLO element 2730, a broadcast element 2770, a logout element 2740, an incident report element 2750, and an emergency responder communication element 2760.

In some embodiments, the history element 2710 may be a user selectable interactive element (such as, but not limited to, a touch location, a button, or a click location). When selected, an archive of messages including instructions, notices, and/or the like may be displayed. In particular, messages that have been send, received, and/or delivered may be displayed. Each message may include a priority level, subject, time received, description, and/or the like. In some embodiments, the messages may be sorted according to the priority level, subject, time received, and/or description when presented to the user.

In various embodiments, the message element 2720 may be a user selectable interactive element. When selected, at least one message may be sent from one of the mobile device 150, the reporting mobile device 1620, the client device 140, or the other mobile devices 1630 to at least one another one of these devices via the network 130. In some embodiments, once the message element 2720 has been selected, a list of preset messages may be displayed to the user. The preset messages may include notices of false alarm, assault, attempted burglary, ban notice, customer service, non-criminal other, vandalism, arrest by security, theft, slip and fall, lost property, water leak, property damage, fire, tenant lease violation, personal accident, burglary from motor vehicle, improper conduct, vehicle accident, active shooter, and/or the like. In various embodiments, the preset messages may include at least one text field for the user to fill.

The preset messages displayed to the user may be based on the role of the corresponding device and/or the user. Users and/or the mobile devices (e.g., the mobile device 150, reporting mobile device 1620, client device 140, and/or other mobile devices 1630) may have different set of preset messages available to them based on the associated role. In addition, a group of users that the user may send messages to or receive messages from may also vary based on roles in the manner described. When displaying the message, graphical indicia and/or text may indicate the current status of the message. The current status may refer to whether the message may be transmitted, received, read, replied, and/or the like. At least one graphical indicia may be associated with each type of status. For example, a graphical indicium may indicate whether the message has been transmitted. The graphical indicium may be in a first graphical state (e.g., red, unchecked, hollow, and/or the like) when the message has not yet been transmitted. The graphical indicium may be in a second graphical state (e.g., green, checked, darkened, and/or the like) when the message has been transmitted. In further embodiments, at least one indication may be displayed as to a number indicating users (e.g., associated mobile devices) that have received, read, and/or replied the message.

In various embodiments, the users of the mobile devices may select to whom the message may be sent to. As described, each user may send messages to a predetermined subset of all users on the network based on the role of the user (e.g., the user who wishes to send the messages).

In response to the user selecting the at least one preset message, the preset message may be sent, from one of the mobile device 150, the reporting mobile device 1620, the client device 140, or the other mobile devices 1630 to another one (or more) of these devices via the network 130. Each preset message may include a subject matter, a content, and/or a set instructions (e.g., lock down procedures, duck-and-cover, and/or the like). In some embodiments, the sending of one or more preset messages may trigger the transmitting device to display a message or a set of instructions to the user of the transmitting device. In further embodiments, the transmitting device may send the message to the receiving device directly, through the network 130, or the transmitting device may send the message to the backend device 110 first, before the message may be sent to the receiving device.

In some embodiments, the user of the transmitting device may select one or more receiving devices or groups of receiving devices to transmit the message to by selecting a corresponding user interactive element. Each user interactive element may correspond to one receiving device or one group of receiving devices. Some messages for different receiving devices or groups of devices may be the same. Some messages may differ in at least one of the following: the subject matter, the content, and the set instructions. In various embodiments, the messages generated for each of the receiving devices may be based on the role associated with the receiving device in the manner described.

In further embodiments, the message interface 2700 may be configured to allow the user to input text data, audio data, photograph data, and/or video data. The transmitting device may transmit such data to receiving devices in the manner described separate from the preset message. Alternatively, such data may be sent as a part of the preset message (e.g., where a portion of the preset message may require user input of text, audio, photograph, and/or video data).

In some embodiments, the broadcast element 2770 may enable a broadcast feature that allows the users of the transmitting devices to “broadcast” messages over the network 130 to the receiving devices. In some embodiments, when the broadcast element 2770 is selected, a broadcast message may sent by the transmitting device (e.g., the reporting mobile device 1620) to all devices on the network 130, irrespective of authorization and/or predetermined message groups determined for any of the devices on the network 130. Once broadcasted, the message window may be closed, and the recipient(s) of the broadcasted message may not be able to reply the message. In other examples, at least one user with predetermined privilege may be able to reply the message. In some embodiments, an authorized user and/or personnel may have permission to change the message type from a “message” to a “broadcast,” vice versa.

In some embodiments, the BOLO element 2730 may be a user selectable interactive element which, if selected, may display a list of BOLO messages. Each BOLO message may include a description of the matter/event that the user is to be on the look out for, accompanying text, audio, photographs, and/or videos. In some embodiments, each BOLO message many be categorized according to the nature of BOLO message (e.g., lost child, suspected criminal, dangerous conditions on premise, and/or the like). Selecting a user interactive element corresponding to the category of BOLO may trigger display of all BOLO messages in that category. The list of BOLO messages may also be sorted by date received. Each BOLO message may include an expiration date. The BOLO message may be deleted at the associated expiration date. Alternatively, the BOLO message may not be included in the live update (e.g., from the backend device 110) on or after the expiration date. An acknowledgement may be sent back to the transmitting device (and displayed to the user of the transmitting device) in various suitable manners to indicate that the BOLO has been transmitted, delivered, read, and/or replied to.

In further embodiments, the message interface 2700 may include the logout element 2740. When the logout element 2740 is selected, the message interface 2700 and/or the staff management application may be exited. In some embodiments, the message interface 2700 may also include the incident report element 2750, such that when selected, the message interface 2700 may display a list of past incident reports.

In some embodiments, emergency responder communication element 2760 may be configured as an user interactive element. After selecting the emergency responder communication element 2760 may be configured to automatically dial a number of emergency responders may automatically be dialed. In alternative embodiments, a regular dialer may be displayed with the telephone number for the emergency responders already inputted to the dialer. The user may simply press a dial key to connect to the emergency responders. When the emergency responder communication element 2760 is activated on a reporting mobile device 1620, the incident display interface 2200 may be triggered to be displayed on the backend device 110 in the manner described. In particular, the location of the reporting mobile device 1620 and the associated user information may be displayed in the manner described.

In other words, the emergency responder communication element 2760 may be associated with contacting authorities outside of the (closed) network 130 while the incident report element 2750 may be associated with information propagation within the network 130.

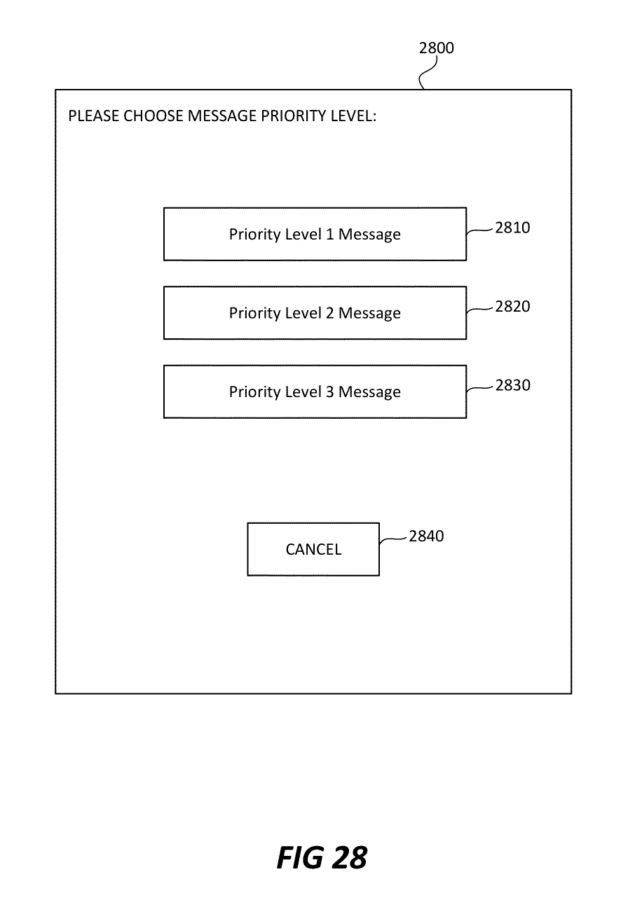

Now referring to FIGS. 1-28, FIG. 28 illustrates a message priority interface 2800 in the form of a display screen according to various embodiments. The message priority interface 2800 may be displayed in response to the message element 2720, BOLO element 2730, and/or broadcast element 2770 being selected. The message priority interface 2800 may be configured to set a priority associated with a message, a BOLO, and/or a broadcast message. The message priority interface 2800 may include a priority levels configured as user interactive elements (e.g., a priority level 1 element 2810, a priority level 2 element 2820, a priority level 3 element 2830, and/or the like).

The priorities may be predetermined based on suitable criteria such as, but not limited to, urgency, likelihood or extend of injury or liability, and/or the like. For example, an event associated with the priority level 1 element 2810 (e.g., the highest priority) may include urgent preparation in setting up for opening in a holiday shopping season. An event associated with the priority level 2 element 2820 (e.g., intermediate priority) may include checking out a booth with dropped merchandise. An event associated with the priority level 3 element 2830 (e.g., the lowest priority) may include sending a message to a designated user or personnel. Other manners and numbers of priority levels may be implemented in similar manner.

The message priority interface 2800 may allow the user to cancel transmission of the message, BOLO, and/or broadcast by providing an user selectable icon 2840 that, if selected, would cancel the message sending and exit the message priority interface 2800.

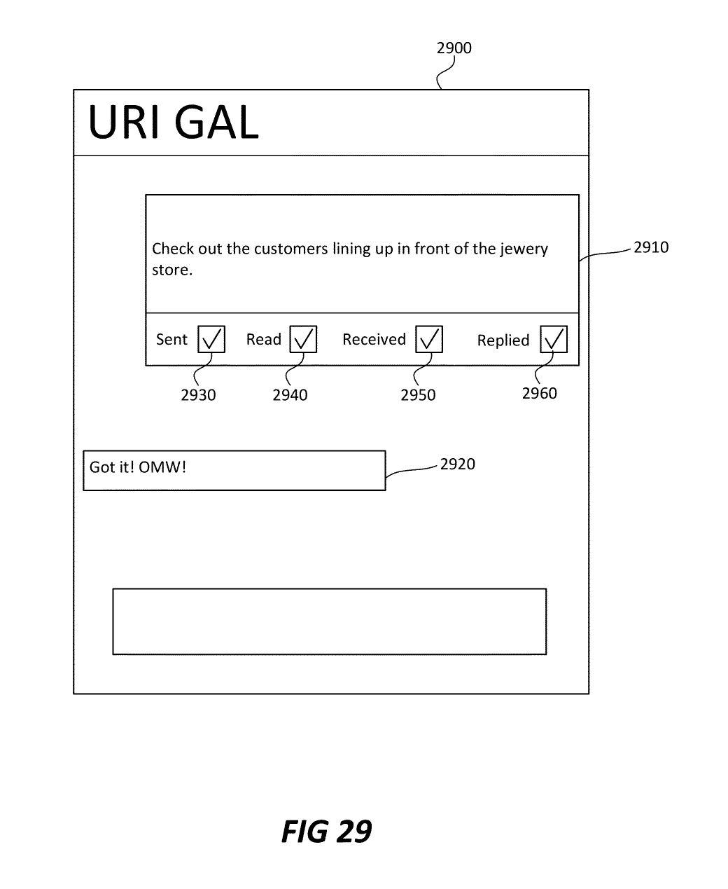

Now referring to FIGS. 1-29, FIG. 29 illustrates a messaging interface 2900 in the form of a display screen according to various embodiments. The messaging interface 2900 may be displayed in response to the message element 2720, BOLO element 2730, and/or broadcast element 2770 being selected and/or a priority level has been selected. The messaging interface 2900 may include a message sent 2910, a reply 2920, a plurality of indicia to indicate the status of the message (e.g., a transmission indicium 2930, read indicium 2940, received indicium 2950, replied indicium 2960, and/or the like).

Each of the plurality of indicia may have a plurality of graphical states used to signify the status of the message. When displaying the message that has been sent by the transmitting device, graphical indicia and/or text may show the current status of the message. For example, the transmission indicium 2930 may be in a first graphical state (e.g., red, unchecked, hollow, and/or the like) when the message has not yet been transmitted. The transmission indicium 2930 may be in a second graphical state (e.g., green, checked, darkened, and/or the like) when the message has been transmitted. In another example, the replied indicium 2960 may be in a first graphical state (e.g., red, unchecked, hollow, and/or the like) when the message has not yet been replied to. The replied indicium 2960 may be in a second graphical state (e.g., green, checked, darkened, and/or the like) when the message has been replied (e.g., as seen by the reply 2920).

When the message, BOLO, and/or broadcast is sent to a plurality of users/mobile devices, an indication may be displayed to indicate a number of individuals (e.g., devices) that have received, read, and/or replied the message.

In various embodiments, the advantages associated with retrieving information from the backend device 110 instead of storing information locally from the mobile device 150, even though the mobile device 150 may be capable of storing such information, include, but not limited to, sending uniform data to all connected devices for maintaining uniform control. This also prevent the users and/or unauthorized users from tempering with the devices to falsify, alter, or obtain unauthorized information.

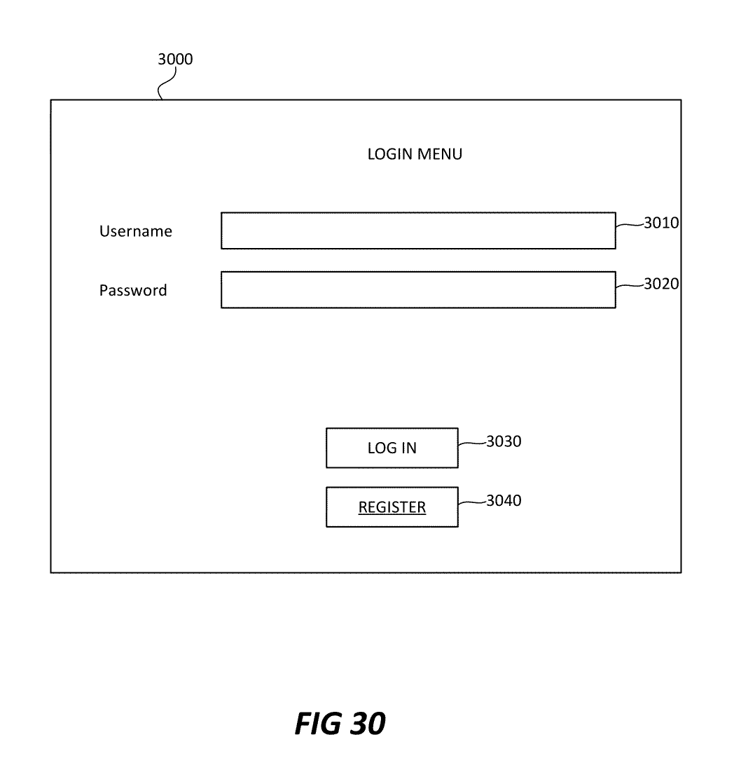

Referring to FIGS. 1-30, the mobile device 150 may display a login interface 3000 to the user through the display device 330 of the mobile device 150. The login interface 3000 may be an interface alternative to the login interface 500. In some embodiments, the login interface 3000 may be initiated and displayed when the user indicates a desire to use the staff management application on the mobile device 150 by perform actions such as, but not limited to, selecting a user-selectable icon representing the staff management application through the user input device 340 of the mobile device 150. As shown in FIG. 30, the login interface 3000 may include a username section 3010, a password section 3020, a login element 3030, and a register element 3040. The username section 3010 and the password section 3020 may each include a text field (or other interactive elements that may receive text and voice input from the user, such as an element for enabling voice commands) for receiving input for receiving a username and/or password. The login element 3030 may be selected by the user to start a login process in which the username entered in the username section 3010 and the password entered in the password section 3020 may be authenticated by the mobile device 150, the backend device 110, and/or other suitable devices, as described.

The register element 3040, when selected, may allow a user who is not registered with the backend device 110 or other suitable devices to permanently or temporarily become a part of the staff management system 100 using the mobile device 150. For example, a unregistered user (e.g., a public user) may download the platform (e.g., an application) on the mobile device 150. Then, the public user may register with the backend device 110 in the manner described, at least with respect to the login interface 3000. Once registered, the public user may use one or more features of the platform as described herein.

For example, public users may receive messages related to a role associated with the public users. Such messages may be an evacuation notice, lost child notice, suspicious person notice, or the like. The public user may also report or upload attachments related to a suspicious person/activity, to be reviewed by the personnel operating the backend device 110 in a similar manner. The public user may additionally receive alerts distributed by the backend device 110 related to a suspicious person or activity. Furthermore, the public user may request assistance from the personnel operating the backend device 110. Still further, the public user may receive non-emergency communications/messages regarding early closure, parking tips, parking tickets, store promotions, or the like.

Similarly, different features of the platform may be enabled for the public users based on geo-location (as defined by the geo-location device 360). The mobile device 150 of the public user or the backend device 110 may identify, based on the output of the geo-location device 360, whether the public user is within at least one first zone (e.g., a safe zone). Features of the platform may be enabled or disabled based on whether the user is within the first zone. In particular embodiments, when the public user is outside of a first zone, the public user may only be limited to calling a public emergency number (e.g., “911”) using the platform. A silent indication alert may be triggered to be sent to the backend device 110 in response. However, the mobile device 150 would not be locked, thus other features are fully functional. When the public user is within the first zone, features of the platform predefined as “public” (e.g., messaging features, alert features, or the like) may be enabled for use by the public user, pending permission from the public user.

In a university setting, the staff, cleaning crew, or security personnel may use the mobile device 150 that displays the login interface 500 (as private users). On the other hand, students interested in using at least some features (e.g., receiving messages) of the mobile device 150 may be shown the login interface 3000, to allow first time users to register as public users. Similar examples may include a conference setting, a cruise ship setting, a mall setting, and the like in which a group of private users (e.g., staffs) and a group of public users (e.g., the attendees or customers) may all benefit from one or more features of the platform as described herein. In further embodiments, the first-time public users are pre-registered based on ID numbers, name, or other types of identification information.

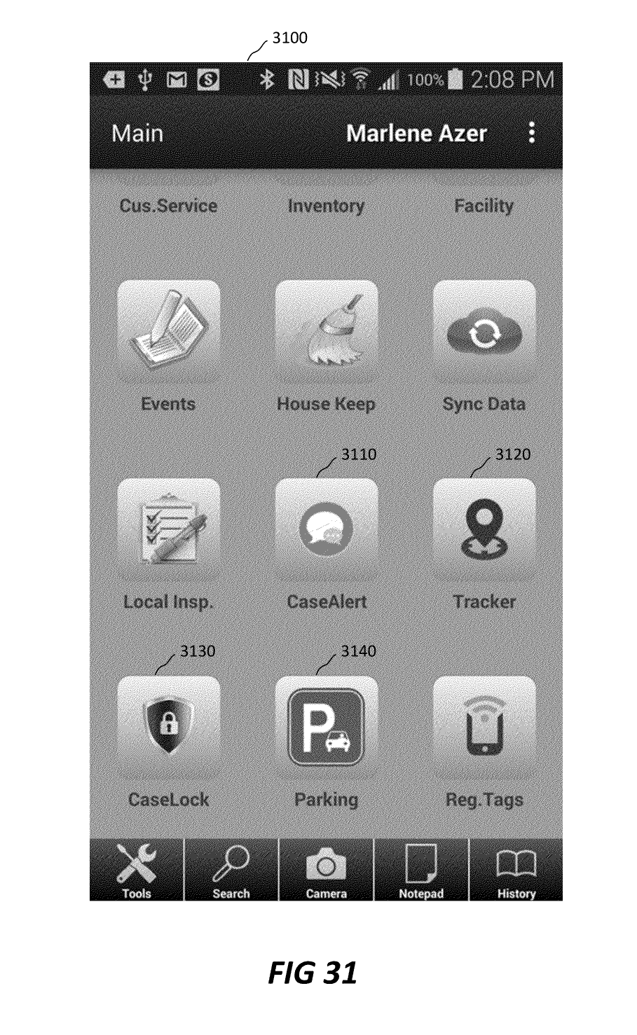

Referring to FIGS. 1-31, illustrated is an example of a selection interface 3100, in the form of a display screen for a touch screen display device. The selection interface 3100 may be a further screen that continues from (a screen that is shown when the selection interface 700 is scrolled down) the selection interface 700. The selection interface 3100 may include a plurality of user interactive elements, including user interactive elements 3110-3140 (such as touch locations, buttons, or click locations) for selecting from among a corresponding plurality of operations, each represented by a separate one of the user interactive elements 3110-3140. In some embodiments, the selection interface may be configured to be presented to the user, by the mobile device 150 via the display device 330, after a successful login authentication as described, similar to the selection interface 700. The selection interface 3100 may include a case alert element 3110, a device tracker element 3120, a case lock element 3130, and a parking violation element 3140 for performing features and functions described herein.

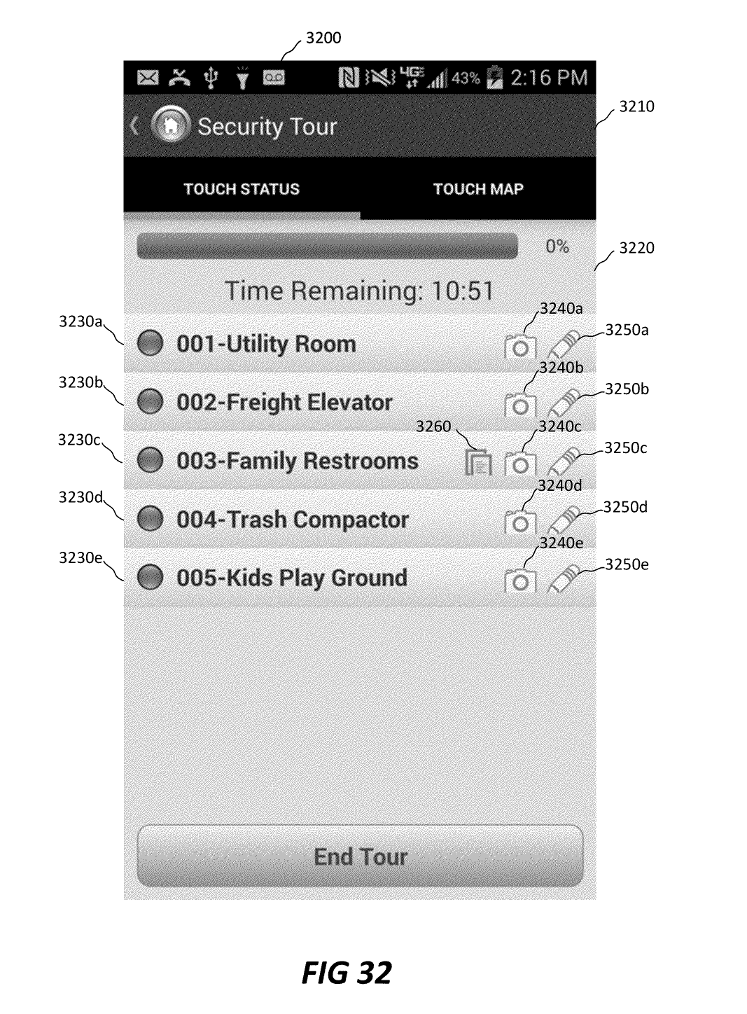

Now referring to FIGS. 1-32, the mobile device 150 may display to the user a tour information overview interface 3200, as illustrated by FIG. 32, according to various embodiments. The tour information overview interface 3200 may be an alternative embodiment to the tour information over view interface 1200. The tour information overview interface 3200 may be displayed by the mobile device 150 after a tour has been selected by a user in the tour selection interface 1100. In some embodiments, the tour information overview interface 3200 may include a tour name 3210, time display 3220, a checkpoint list displaying a plurality of check points 3230a-3230e. Each of the plurality of checkpoints 3230a-3230e may include a title and/or concise description that sufficiently identifies the checkpoint to the user. The time display 3220 may be configured to display a remaining period of time in which the tour may be completed in. In some embodiments, the time display 3220 may be associated with a timed tour as described.

Each of the plurality of checkpoints 3230a-3230e may be associated with one of attachment elements 3240a-3240e for adding a file (e.g., an image, video, audio, or other types of files) associated with a corresponding checkpoint. In further embodiments, each of the checkpoints 3230a-3230e may be associated with one of comment elements 3250a-3250e for adding comments in text format. An attachment indicator 3260 may be included to show that an attachment (using the attachment element 3240c) and/or a comment (using the comment element 3250c) have already been added.

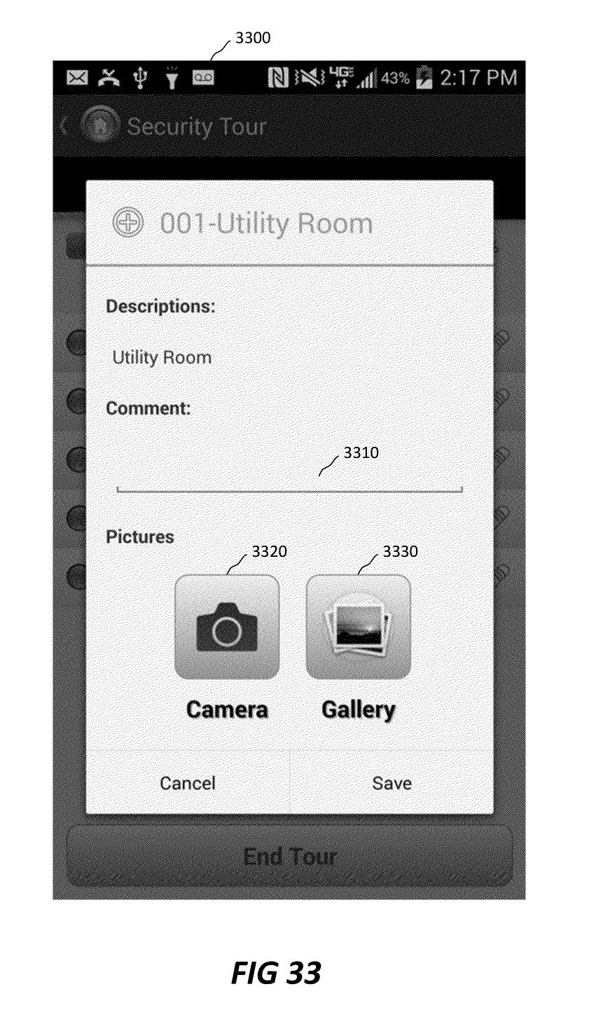

Now referring to FIGS. 1-33, the mobile device 150 may display to the user an attachment interface 3300, as illustrated by FIG. 33, according to various embodiments. The attachment interface 3300 may be displayed by the mobile device 150 after one (e.g., the attachment element 3240a) of the attachment elements 3240a-3240e or one (e.g., the comment element 3250a) of the comment elements 3250a-3250e has been selected by the user. The attachment interface 3300 may include a comment text field 3310 to receive user input of comments related to the checkpoint 3230a. The attachment interface 3300 may also include a camera element 3320 for activating the camera of the user input device 340 for taking at least one video/image to be associated with the checkpoint 3230a. The attachment interface 3300 may include a gallery element 3330 for retrieving at least one video/image from the memory 320 to be associated with the checkpoint 3230a.

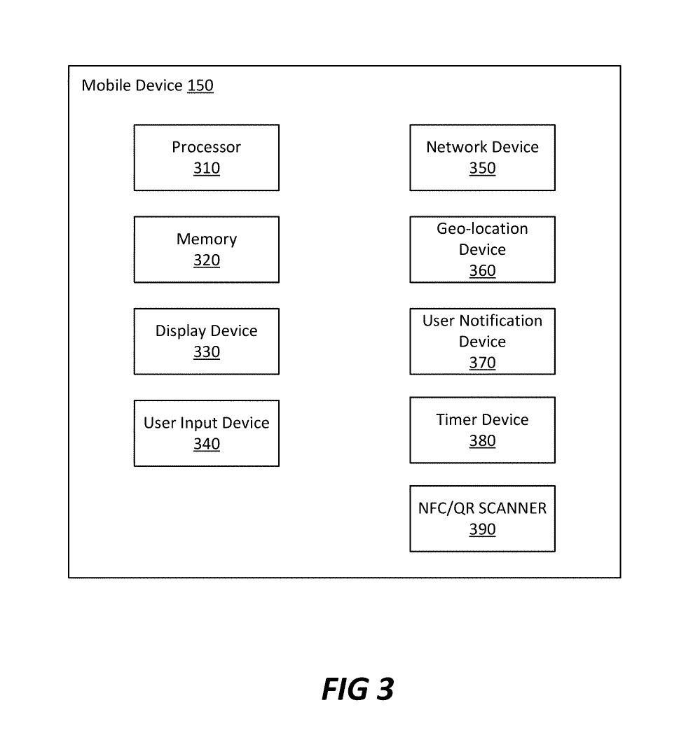

Various embodiments described above with reference to FIGS. 1-33 include the performance of various processes or tasks. In various embodiments, such processes or tasks may be performed through the execution of computer code read from computer-readable storage media. For example, in various embodiments, one or more computer-readable storage mediums store one or more computer programs that, when executed by a processor such as the processor 210 (refer to FIG. 3), the processor 310 (refer to FIG. 3), and the processor 410 (refer to FIG. 4) cause the processor to perform processes or tasks as described with respect to the processor 210 the processor 310, and the processor 410 in the above embodiments. Also, in various embodiments, one or more computer-readable storage mediums store one or more computer programs that, when executed by a device such as the backend device 110 (refer to FIGS. 1 and 2), the client device 140 (refer to FIGS. 1 and 4), the mobile device 150 (refer to FIGS. 1 and 3), the reporting mobile device 1620 (refer to FIG. 16), and the other mobile devices 1630 (refer to FIG. 16) cause the computer to perform processes or tasks as described with respect to the devices mentioned in the above embodiments. In various embodiments, one or more computer-readable storage mediums store one or more computer programs that, when executed by a database such as the database 120 (refer to FIG. 1), cause the database to perform processes or tasks as described with respect to the database 120 in the above embodiments.

Thus, embodiments within the scope of the present invention include program products comprising computer-readable or machine-readable media for carrying or having computer or machine executable instructions or data structures stored thereon. Such computer-readable storage media can be any available media that can be accessed, for example, by a general purpose or special purpose computer or other machine with a processor. By way of example, such computer-readable storage media can comprise semiconductor memory, flash memory, hard disks, optical disks such as compact disks (CDs) or digital versatile disks (DVDs), magnetic storage, random access memory (RAM), read only memory (ROM), and/or the like. Combinations of those types of memory are also included within the scope of computer-readable storage media. Computer-executable program code may comprise, for example, instructions and data which cause a computer or processing machine to perform certain functions, calculations, actions, or the like.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. Various modifications and changes that come within the meaning and range of equivalency of the claims are intended to be within the scope of the invention.

What is claimed is:

1. A method for responding to or planning for an event, the method comprising:
receiving, by a server over a network, a notice indicating the occurrence of the event at a facility;
classifying, by the server, the event based at least in part on the notice,
generating, by the server, at least one message corresponding to each of at least one device, wherein each of the at least one message is generated based, at least in part, on at least one role associated with the each of the at least one device; and
transmitting, by the server over the network, the at least one message to the each of the at least one device.

2. The method of claim 1, further comprising requesting, by the server, additional data from a mobile device.

3. The method of claim 2, wherein the requesting comprises:
activating, by the server, a communication device of the mobile device; and
receiving, by the server, the additional data obtained from the communication device.

4. The method of claim 3, wherein the communication device is at least one of: a photographic camera of the mobile device, a video camera of the mobile device, and a microphone of the mobile device.

5. The method of claim 2, wherein the notice is sent by the mobile device.

6. The method of claim 1, wherein the generating comprises:
retrieving rules based, at least in part, on the at least one role associated with the each of the at least one device; and
selectively generating the at least one message based, at least in part, on the rules and the notice.

7. The method of claim 1, wherein the notice comprises at least one of: a geo-location data representing a geological location in which the event occurs, a time stamp representing the time at which the event occurred, and a user comment.

8. The method of claim 7, wherein the geo-location data further comprises at least one of: a section of the facility associated with the geological location, an identification of the section, an address associated with the section, contact information associate with the section, and a map representing the section.

9. The method of claim 7, wherein the user comment is at least one of the following: a text input, a voice input, a photographic input, and a video input.

10. The method of claim 1, further comprising displaying, with the server to a personnel associated with the server, a presentation of the event, the presentation comprising at least one of: a map showing a location of the event, a classification of the event, a time stamp of the event, contact information, and information of the identity of a user associated with a mobile device.

11. The method of claim 1, wherein the transmitting comprises forcing, by the server, the at least one device to display the corresponding at least one message.

12. The method of claim 1, wherein the at least one message comprises a set of at least one instruction for responding to the event.

13. A system for responding to or planning for an event, comprising:
a mobile device;
a plurality of devices; and
a server configured to
receive a notice indicating the occurrence of the event at a facility;
classify the event based at least in part on the notice,
generate at least one message corresponding to each of at least one device, wherein each of the at least one message is generated based, at least in part, on at least one role associated with the each of the at least one device; and
transmit the at least one message to the each of the at least one device.

14. The method of claim 13, wherein the server is further configured to request additional data from a mobile device.

15. The method of claim 14, wherein the server is further configured to
activate a communication device of the mobile device; and
receive the additional data obtained from the communication device.

16. The method of claim 15, wherein the communication device is at least one of: a photographic camera of the mobile device, a video camera of the mobile device, and a microphone of the mobile device.

17. The method of claim 15, wherein the mobile device is configured to send the notice.

18. The method of claim 13, wherein the generating comprises:
retrieving rules based, at least in part, on the at least one role associated with the each of the at least one device; and
selectively generating the at least one message based, at least in part, on the rules and the notice.

19. The method of claim 13, wherein the notice comprises at least one of: a geo-location data representing a geological location in which the event occurs, a time stamp representing the time at which the event occurred, and a user comment.

20. The method of claim 19, wherein the geo-location data further comprises at least one of: a section of the facility associated with the geological location, an identification of the section, an address associated with the section, contact information associate with the section, and a map representing the section.

21. The method of claim 19, wherein the user comment is at least one of the following: a text input, a voice input, a photographic input, and a video input.

22. The method of claim 13, the server is further configured to display to a personnel associated with the server, a presentation of the event, the presentation comprising at least one of: a map showing a location of the event, a classification of the event, a time stamp of the event, contact information, and information of the identity of a user associated with a mobile device.

23. The method of claim 13, wherein the server is further configured to force the devices to display the message.

24. The method of claim 13, wherein the at least one message comprises a set of at least one instruction for responding to the event.

25. A method for responding to or planning for an event, comprising:
receiving user input indicating the occurrence of the event at a facility;
determining whether a user had cancelled sending a notice with a predetermined period of time; and
sending the notice automatically when the user has not cancelled the sending of the notice.
